(19) United States
(12) Patent Application Publication
(10) Pub. No.: US 2003/0014266 A1
(43) Pub. Date: Jan. 16, 2003

(54) Automated transactions of the funeral process

(75) Inventors: Christopher C. Brown, Dellwood, MN (US); Daniel B. Garrity, Bloomington, MN (US); Bruce G. Bratton, Woodbury, MN (US)

Correspondence Address: MERCHANT & GOULD PC, P.O. BOX 2903, MINNEAPOLIS, MN, 55402-0903, US

(73) Assignee: Funeral.com, Inc.

(21) Appl. No.: 09/770,318

(22) Filed: Jan. 26, 2001

(51) Int. Cl. G06F 17/60

(52) U.S. Cl. 705/1

(57) ABSTRACT

Methods and an associated apparatus for automating the funeral planning process are disclosed. Some methods involve providing a virtual funeral related transaction site to enable consumers to make selections electronically to plan a funeral without the need to visit a funeral home or interact directly with a funeral director. Some methods also involve providing a virtual funeral related transaction site to enable funeral service providers to make product selections from the offerings of suppliers where the product selections will ultimately be offered to consumers. Some methods also involve providing a predetermined set of steps that are implemented by the consumer's computer to assist the consumer in planning the funeral.

### TECHNICAL FIELD

The present invention relates to automating transactions of the funeral process and more specifically, to computer implemented methods for providing funeral-related options and transaction capabilities.

### BACKGROUND

The conventional funeral planning process is often considered unpleasant by consumers who must visit a funeral home or at least interact with a funeral director. The consumer often feels pressured and uncomfortable and wants the process to end as quickly as possible, yet knows that the funeral process requires much planning and guidance. The consumer often feels overwhelmed by the numerous decisions that must be made and may make uninformed choices in an effort to speed the process to an end. Typically, a death has already occurred and the consumer is attempting to plan the funeral for the loved one who has died. The grief felt by the consumer adds to the uncomfortable funeral home setting. The consumer may feel overly susceptible to influence by the funeral director in this environment.

Furthermore, for those consumers who pre-plan some or part of the funeral process, such as selecting a burial plot and other funeral related options, dealing with salesmen regarding one's own funeral plans may seem awkward and otherwise uncomfortable. Again, the consumer may feel pressured and overly susceptible to influence. The consumer will desire to end the process, as quickly as possible, and may make undesirable compromises as a result.

Funeral home and funeral directors compete for the business of consumers, but because of the sensitive nature of their business, they must avoid aggressiveness in attempting to persuade consumers. Funeral related service and product suppliers, such as casket makers, must target funeral homes and directors to persuade them to offer the supplier's products to consumers during the funeral planning process. Similarly, product suppliers may need to rely upon consumers to request and/or choose their products, but because of the nature of the products, the suppliers also must avoid aggressive advertising.

Thus, consumers are often placed in uncomfortable and compromising positions when dealing with funeral homes and directors, while the funeral service and product suppliers cannot employ ordinary marketing and sales tactics aimed at consumers for fear of alienating their customers, the funeral homes. As a result, funerals are planned without full considerations of options available to consumers as well as options available to funeral service providers and product suppliers.

### SUMMARY

One embodiment of the invention may be viewed as a computer-network apparatus or method for integrating communication between parties involved with the funeral process. The apparatus includes a memory having first and second storage locations where the first storage location includes data related to funeral product information and the second storage location includes data related to funeral home information. A network server in data communication with the memory and having a network interface is also included. The network server has a processor configured to (i) receive electrical signals embodying funeral product information through the interface from a supplier client device, and store the funeral product information in the first storage location; (ii) provide electrical signals embodying funeral product information stored in the first storage location to a funeral home client device through the interface; (iii) receive electrical signals embodying funeral home information from the funeral home client device through the interface, the funeral home information including selections from information stored in the first storage location, and store the funeral home information in the second storage location; and (iv) provide electrical signals embodying funeral home information stored in the second storage location to a consumer client device through the interface.

The invention may also be viewed as another computer-network apparatus or method for integrating communication between parties with the funeral process. This apparatus includes a memory for storing funeral process information and a network server in electrical communication with the memory and a network interface. The network server includes a processor configured to (i) provide an electrical signal embodying a menu of funeral process items to a client device through the interface, each menu item corresponding to a set of data stored in the memory, (ii) determine the appropriate set of data to retrieve from the memory in response to selection of one of the memory items, and (iii) provide an electrical signal embodying the appropriate set of data to the client device through the interface.

Furthermore, the invention may be viewed as a computer data signal embodied in a transmitted wave readable by a computer system and encoding a computer program of instructions for executing a computer process. The computer process includes (i) displaying, in a sequence, a funeral plan option from a set of funeral plan options on a display of a client device for executing the computer process, (ii) receiving a funeral plan option selection through an input device of the client device, (iii) proceeding to a next funeral plan option to receive another funeral plan option selection, and (iv) transmitting from the client device a computer data signal embodying the funeral product option selections made during each of the funeral planner steps.

### DRAWINGS

FIG. 1A shows a network environment suitable for practicing embodiments of the present invention.

FIG. 1B shows in more detail an exemplary production server of FIG. 1 and its database structure.

FIG. 1C depicts the process module structure executed by the production server in one embodiment.

FIG. 2 illustrates the funeral home microsite development process of one embodiment.

FIG. 3 depicts the package pricing procedure as specified in the funeral home microsite of an embodiment.

FIG. 4 shows a package modification process of an embodiment.

FIG. 5 illustrates the transactional process of a consumer purchase from funeral options as provided by an embodiment.

FIG. 6 depicts the transactional process of a funeral service provider purchasing funeral products from a supplier as provided by an embodiment.

FIG. 7 shows the transactional process of a funeral service provider purchasing service from the virtual funeral transaction site provider as provided by an embodiment.

FIG. 8 illustrates the registration process of funeral service providers as well as product and service suppliers with the virtual funeral transaction site provider as provided by an embodiment.

FIG. 9 depicts the transactional process for consumers obtaining pre-paid funeral-related legal services as provided by an embodiment.

FIG. 10A shows a first portion of the transactional process of a funeral planner module of one embodiment.

FIG. 10B shows a second portion of the transactional process of FIG. 10A.

FIG. 11 illustrates a transactional process of a training and consulting module as provided by an embodiment.

FIG. 12 depicts a consumer portion of a funeral insurance transactional process for consumers obtaining coverage on a pre-need basis as provided by an embodiment.

FIG. 13 shows a funeral home portion of the funeral insurance transactional process.

FIG. 14 illustrates a transactional process for funeral service providers as well as product and service suppliers placing advertisement content on the virtual funeral transaction site as provided by an embodiment.

FIG. 15 depicts the transactional process for funeral service providers as well as product and service suppliers obtaining virtual transaction site reports as provided by an embodiment.

FIG. 16 shows the top-level paging modules maintained by a production server of an exemplary virtual funeral transaction site.

FIG. 17 illustrates the next level of the exemplary funeral directors paging module.

FIG. 18 depicts the next level of the exemplary cemeteries paging module.

FIG. 19 shows the next level of the exemplary suppliers paging module.

FIG. 20 illustrates the next level of exemplary consumer paging module.

FIG. 21A depicts a first portion of the exemplary pre-need planning sub-module of the consumer paging module.

FIG. 21B shows a second portion of the exemplary pre-need planning sub-module of the consumer paging module.

FIG. 22 illustrates the exemplary remains sub-module of the consumer paging module.

FIG. 23A depicts a first portion of the exemplary funeral planning sub-module of the consumer paging module.

FIG. 23B shows a second portion of the exemplary funeral planning sub-module of the consumer paging module.

FIG. 24 illustrates the exemplary planner/wizard option of the funeral planning sub-module.

FIG. 25A depicts a first portion of the exemplary obituaries sub-module of the consumer paging module.

FIG. 25B shows a second portion of the exemplary obituaries sub-module of the consumer paging module.

FIG. 26 illustrates the exemplary cemeteries sub-module of the consumer paging module.

FIG. 27 depicts the exemplary grieving sub-module of the consumer paging module.

FIG. 28 shows the exemplary cultural perspective sub-module of the consumer paging module.

FIG. 29 illustrates the exemplary resources sub-module of the consumer paging module.

FIG. 30 depicts the exemplary kids sub-module of the consumer paging module.

FIG. 31 shows the exemplary pets sub-module of the consumer paging module.

FIG. 32 illustrates an exemplary screen display of a virtual transaction site theme selection page as provided to a consumer client device.

FIG. 33 depicts an exemplary screen display of a virtual transaction site pricing page as provided to a consumer client device.

FIG. 34 shows an exemplary screen display of a virtual transaction site funeral home locator page as provided to a consumer client device.

FIG. 35 illustrates an exemplary screen display of a virtual transaction site general pricing list set up page as provided to a funeral service provider client device.

### DETAILED DESCRIPTION

Various embodiments of the present invention will be described in detail with reference to the drawings, wherein like reference numerals represent like parts and assemblies through the several views. Reference to various embodiments does not limit the scope of the invention, which is limited only by the scope of the claims attached hereto.

Embodiments of the present invention provide a central database server creating a virtual transaction site enabling consumers to plan a funeral through a computer rather than relying solely on a funeral director. These embodiments provide computer programming modules that assist the consumer making informed decisions regarding the funeral process by providing appropriate information regarding funeral homes, funeral services, and funeral products. Furthermore, some embodiments guide the consumer through the funeral planning process by providing computer programming modules that implement a predetermined set of steps to obtain information and option selections from the consumer. These embodiments further provide a central database server that allows the consumer to have the planned funeral scheduled for execution by a selected funeral home in communication with the central database server.

Embodiments of the present invention also provide funeral service providers (i.e., funeral homes and/or directors) and funeral product suppliers (i.e., casket manufacturers, cemetery owners, etc.) with a centralized computer implemented transaction site for offering their services and/or products. Embodiments provide databases and network interfaces that permit the funeral service providers to obtain products necessary for execution of planned funerals by shopping for products from suppliers who have registered their products with the virtual transaction site.

The logical operations of the various embodiments of the invention described herein are implemented as: (1) a sequence of computer-implemented steps running on a computing system; and/or (2) interconnected machine modules within the computing system. Modules represent functions executed by computer program code such as the HTML code found in web pages, as discussed below. The implementation is a matter of design choice dependent on the performance requirements of the virtual transaction site and associated network server. Accordingly, the logical operations making up the embodiments of the invention described herein are referred to alternatively as operations, steps, or modules.

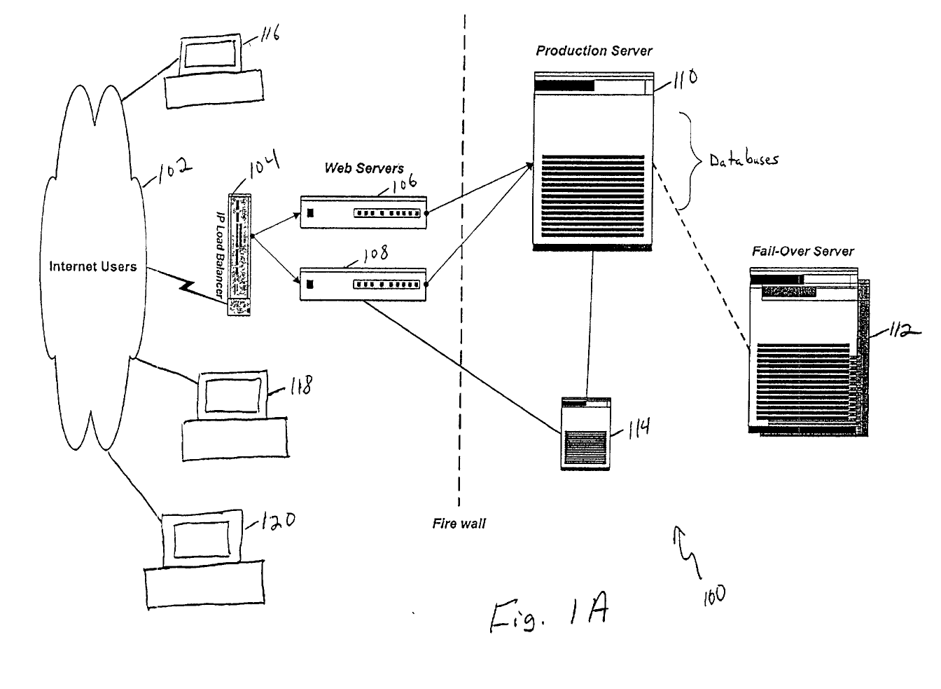

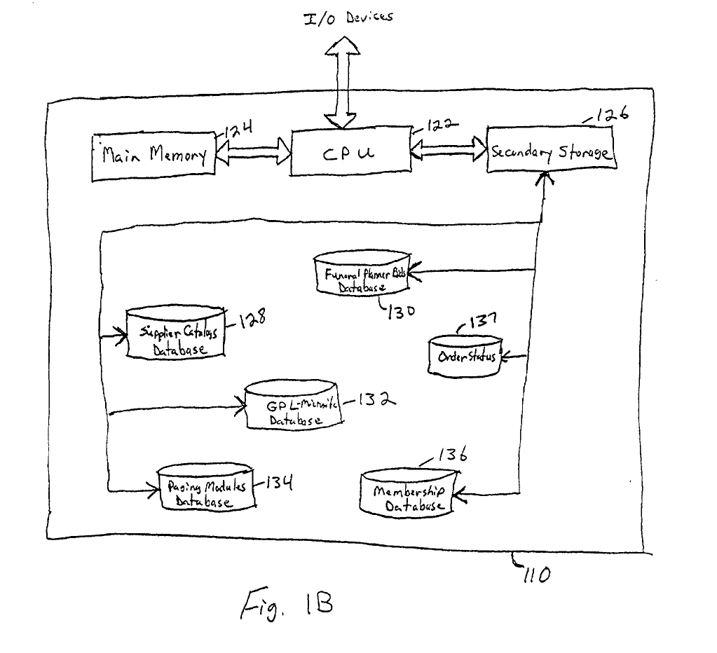

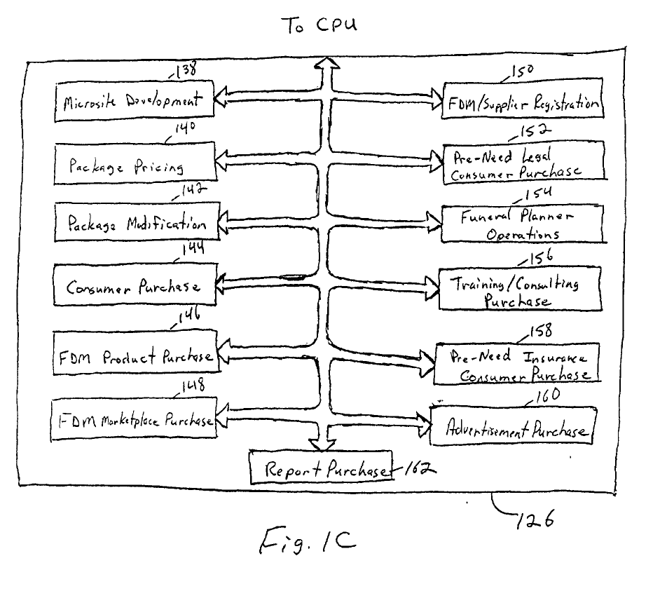

FIG. 1 illustrates a network environment that typically facilitates the virtual transaction site. Other network environments are possible. The exemplary virtual transaction site 100 consists of several servers maintaining databases of information on storage media such as disc or tape drives. A production server 110 typically contains all of the consumer, funeral service provider, and product supplier information, including the individual products and services for each entity, packages of good and services, and transactional information. The production server 110 also contains components and programming, as discussed with reference to FIG. 1B and FIG. 1C.

A fail-over server 112 is linked to the production server 110 to provide a duplicate set of databases for back-up purposes. An additional server 114 is provided to stage data provided to/from one or more web servers 106 and 108 to further facilitate the data transfer process between the web servers and the production server. An example of a suitable production server 110 and fail-over server 112 is the Sun Enterprise 450. This particular server may be configured with multiple high speed processors, for example 4 400 Mhz cpus with 2 gigabytes (GB) of random access memory (RAM). An Oracle Database may be utilized to implement the database structure shown in FIG. 1B.

The web servers 106 and 108 provide access to the virtual funeral transaction site from the Internet 102. The web servers 106 and 108 provide the code (HTML, JAVA, XML, etc.) through electrical signals that provide the transaction site to the web browser of client devices linked to the Internet that visit the virtual funeral transaction site and receive electrical signals from the client devices in return. An example of a suitable web server is the Sun Netra T1, which may be configured with 1440 Mhz processor and 1 GB RAM.

The client devices include consumer devices 116, funeral service provider devices 118, and supplier devices 120. Each of these devices is typically a personal computer or dedicated Internet device implementing a web browser shown on a display device such as a monitor. Each has a communication port connected to the Internet through an Internet Service Provider (not shown). The communication port may be a modem, Ethernet connection, or other data transfer device.

Typically, the domain name of the virtual funeral transaction site 100 directs the client devices 116, 118, or 120 to one or more load balancers 104 that then channel the client device 116, 118, or 120 to a web server 106 or 108 that can provide the fastest service to the client device 116, 118, or 120 based on server activity and/or geographic location. The web servers 106, 108 then provide the web page data, including funeral service provider and product supplier data retrieved from the production server 110 as necessitated by the navigation by the client device 116, 118, or 120.

FIG. 1B shows the production server 110 in more detail. The production server 110 contains main memory (i.e., RAM) 124 accessible by the one or more central processing units (CPU) 122 that facilitates execution of the processing modules shown in FIG. 1C and typically contained in secondary storage 126 (i.e., disc or tape drives) that is also accessible by the CPU 122. The CPU 122 has access to Input/Output (I/O) devices that enable the production server 110 to receive and transmit data to other devices including the fail-over server 112 and the web servers 106 and 108.

During operation of the virtual transaction site 100, the CPU 122 directs that various data be retrieved from or stored to various database locations as maintained by the secondary storage 126. These locations include various database sections that are each discussed below with reference to corresponding processing modules being implemented by CPU 122. The database sections include a Supplier Catalog database 128 that contains information for funeral related products that can be provided by funeral product suppliers. A general pricing list (GPL)-microsite database 132 contains funeral related product and service information for funeral homes that can be provided by funeral homes. A membership database 136 contains information about product suppliers, funeral service providers, and consumers that is used in completing the automated transactions in relation to funeral planning. The utility of these databases will be discussed in greater detail below.

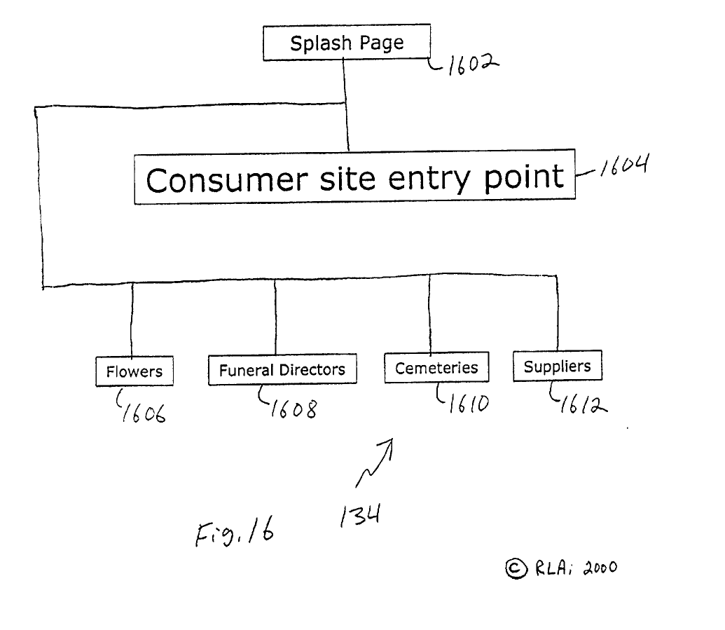

The database sections also include a funeral planner bids database 130 that contains transactional information including bid parameters and values submitted by various funeral homes in response to consumers submitting funeral plan opportunities. A paging modules database 134 may be utilized to keep track of the various web content that is provided to the web servers 106 and 108 that is ultimately transmitted to client devices 116, 118, and 120. The paging module database contains the computer code that provides the display on the client devices 116, 118, and 120 and implements code that the CPU 122 utilizes to determine whether a client device 116, 118, or 120 is attempting to access the virtual transaction site as a consumer, funeral service provider, or product supplier as shown in FIG. 16. An order status database 137 is provided to maintain the status for all orders from product suppliers, funeral service providers, and consumers including the products and/or services ordered, the ordering party, the supplying party, and whether the order has been fulfilled. The utility of these databases also will be discussed in greater detail below.

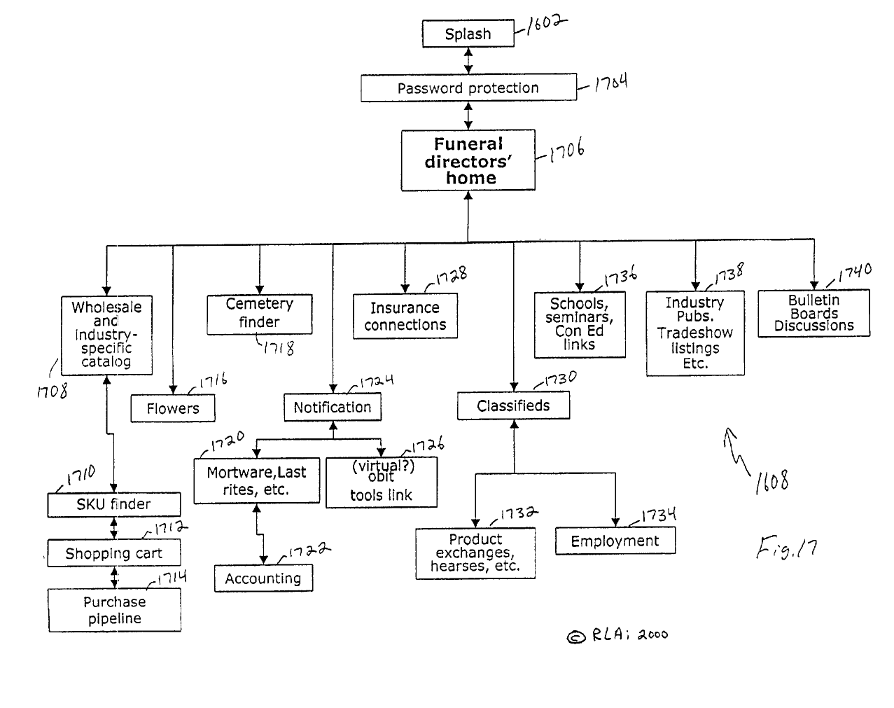

FIG. 1C shows the directory structure of the background process modules maintained by the secondary storage device 126. These process modules operate in conjunction with the paging modules stored in the paging module database 134 to implement the virtual transaction site. The paging modules are utilized to provide the display of information to the client devices 116, 118, and 120 and to receive information provided by the client devices 116, 118, and 120 and return it to the production server 110. At the production server 110, an appropriate background module, as determined by the CPU 122 based on the type of information received and whether from a consumer, funeral service provider, or product supplier, handles the data to facilitate the requested transaction. A microsite development module 138 performs the background process that occurs when a paging module, such as the funeral directors paging module shown in FIG. 17, permits the funeral service providers to submit descriptions and pricing for products and services offered to consumers.

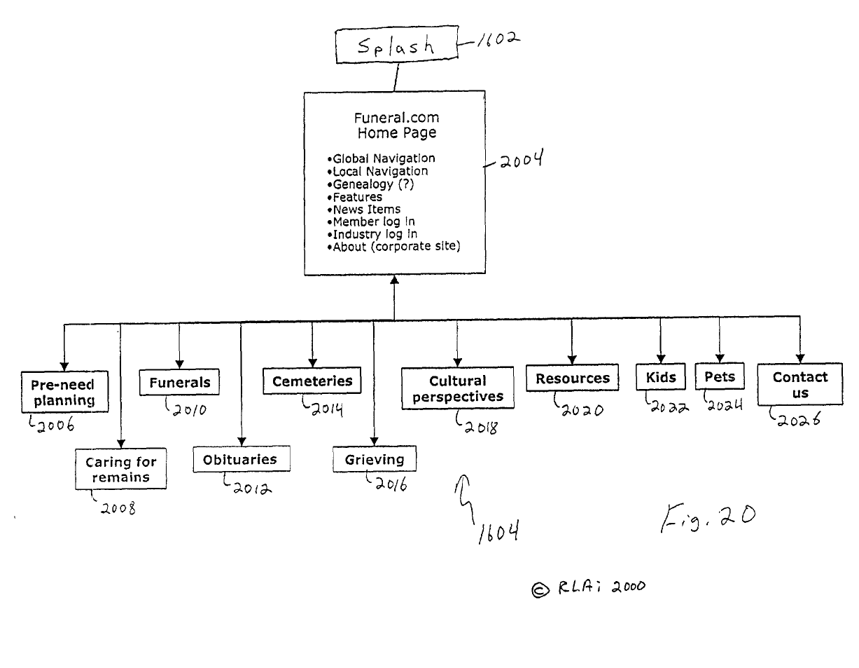

A package pricing module 140 performs the background process that occurs when a paging module, such as the funeral directors paging module shown in FIG. 17, permits funeral service providers to create packages that consumers may choose from to eliminate many of the individual choices that would otherwise be necessary. Typically, these packages of module 140 are comprised of components entered by the funeral service provider through module 138. Package modification module 142 performs the background process that occurs when a paging module, such as the consumer paging module shown in FIG. 20, allows consumers to make changes to the packages created by funeral service providers in module 140 where all elements of the package are not satisfactory.

Also included in the directory structure is a consumer purchase module 144 which demonstrates the background transactional process that occurs when a paging module, such as the consumer paging module shown in FIG. 20, allows consumers to purchase individual products or packages as created for the funeral service providers through operation of modules 138 and 140. A funeral director/manager (FDM) product purchase module 146 performs the background transactional process that occurs when a paging module, such as the funeral director paging module shown in FIG. 17, allows funeral service providers to purchase products from the supplier catalogs of the supplier catalog database 128, which may or may not correspond to the products listed by the FDM through operation of modules 138 and 140.

An FDM transaction site purchase module 148 performs the background transactional process that occurs when a paging module, such as the funeral director paging module shown in FIG. 17, allows funeral service providers to purchase a microsite position on the virtual transaction site. The microsite position purchased through module 148 is then populated with the information received through modules 138 and 140 and is provided to consumers for product and service selection such as through the consumer paging module of FIG. 20. An FDM/Supplier registration module 150 performs the background process that occurs when funeral service providers and product suppliers register their goods and services on the virtual transaction site, such as by creating a microsite and/or completing a GPL within GPL-microsite database 132 is handled by modules 138, 140, and 148, or uploading product catalog entries into catalog database 128. A pre-need legal module 152 performs the background transactional process that occurs when a paging module, such as the consumer paging module shown in FIG. 20, allows a consumer to purchase death related legal service on a pre-need basis.

The secondary storage 126 also maintains a funeral planner module 154 that performs the background operations when a consumer implements the funeral planner through a paging module, such as the consumer paging module shown in FIG. 20, to assist in the decision-making process for purchases ultimately handled by module 144. A training/consulting module 156 performs the background transactional processes that occur when a consumer or funeral service provider purchases training or consulting through a paging module such as the funeral directors paging module shown in FIG. 17. A pre-need insurance module 158 performs the background transactional process that occurs when a consumer purchases funeral related insurance on a pre-need basis through a paging module such as the consumer paging module shown in FIG. 20, as has been supplied by the FDM through the microsite or GPL handled by modules 138 and 140.

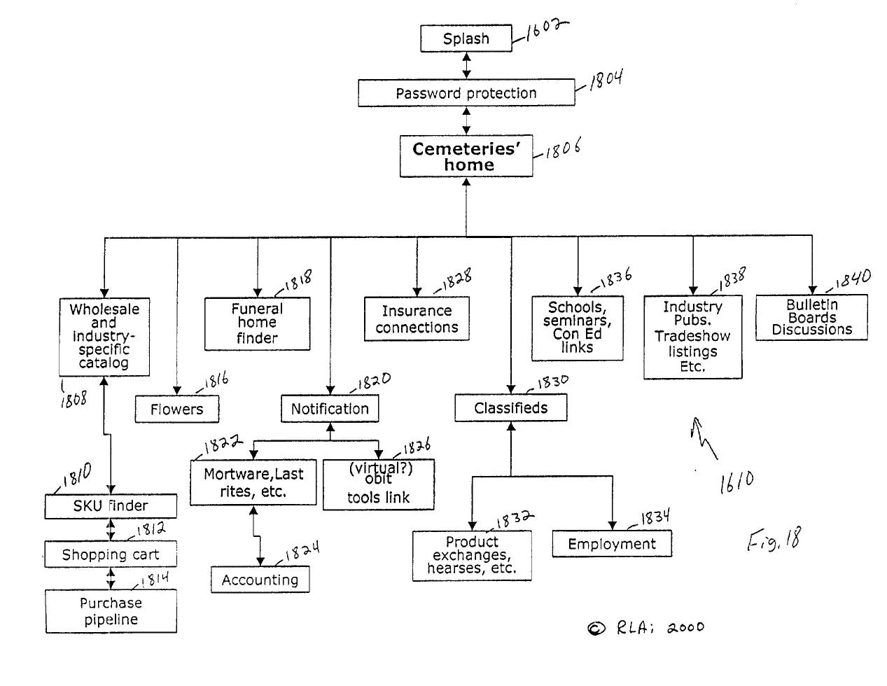

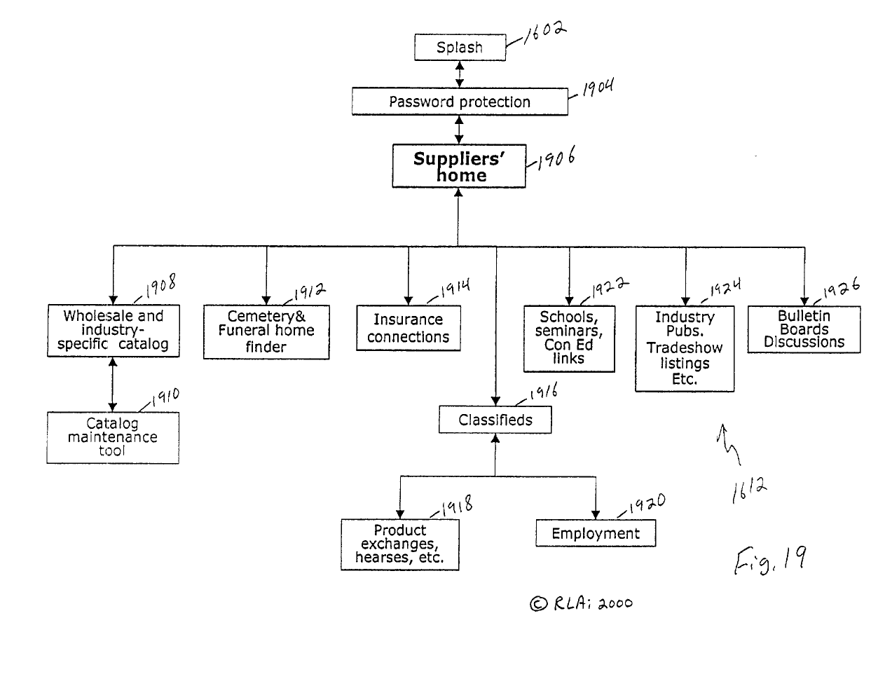

An advertisement purchase module 160 is included to perform the background transactional process that occurs when a funeral service provider, cemetery owner, or product supplier purchases advertising space within the virtual transaction site through a paging module such as the funeral directors paging module of FIG. 17, the cemeteries paging module of FIG. 18, or the suppliers paging module of FIG. 19. A report purchase module 162 performs the background process that occurs when a funeral service provider, cemetery owner, or product supplier purchases a virtual transaction site activity report through a paging module such as the funeral directors paging module of FIG. 17, the cemeteries paging module of FIG. 18, or the suppliers paging module of FIG. 19.

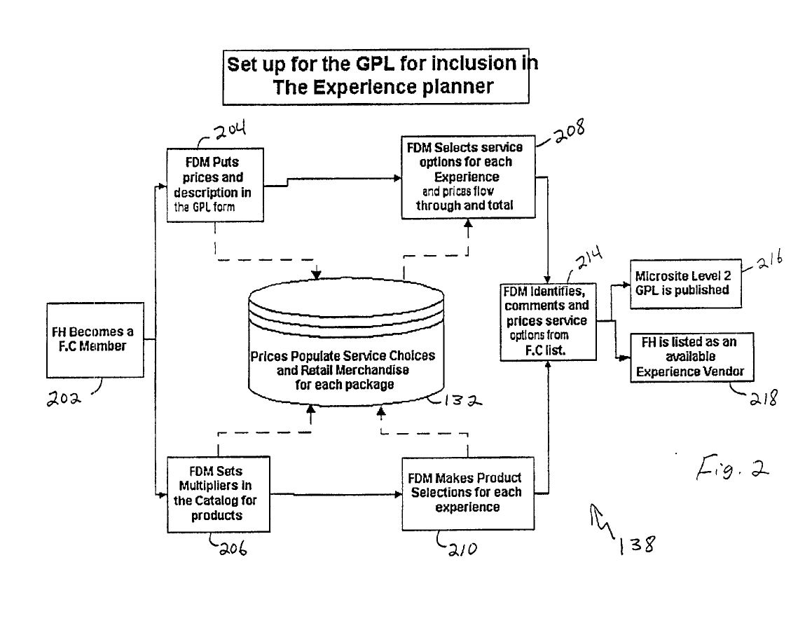

FIG. 2 shows the development process implemented by the GPL-microsite module 138 for a funeral service provider's microsite. A microsite is a web page or set of pages devoted to the services and products offered by the funeral service provider. The microsite permits the consumer to virtually visit the funeral service provider by viewing on-line content about the services and products offered. Consumers may then choose to purchase services and/or products from the funeral service provider by making selections from the microsite.

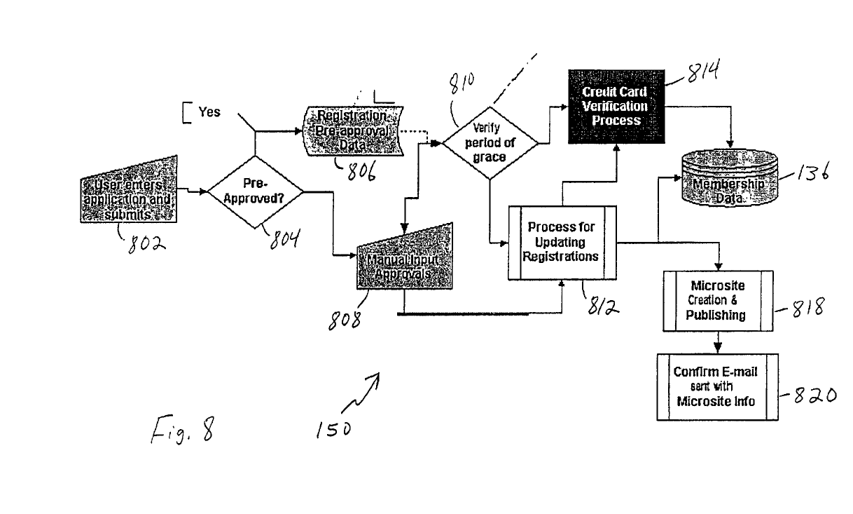

The development process for a microsite begins at member operation 202, where the funeral home/director becomes a member of the virtual transaction site (F.C) by registering (see FIG. 8) with the transaction site provider, for example the Funeral.com™, an Internet based funeral-related transaction site. Registration involves directing the client device (i.e., the funeral service provider) to the web servers, navigating to the appropriate registration site, and providing contact information as well as information enabling the transaction site provider to bill the funeral service provider for facilitating transactions with consumers. Such information may include credit card or dedicated account information and authorization.

After the funeral service provider has registered with the transaction site provider, the funeral service provider, typically through the funeral home director/manager (FDM), provides the products and services content to be maintained in the production server database. The FDM generates service content including the prices and description for the services to be offered to the consumer through the virtual transaction site 100 at content operation 204.

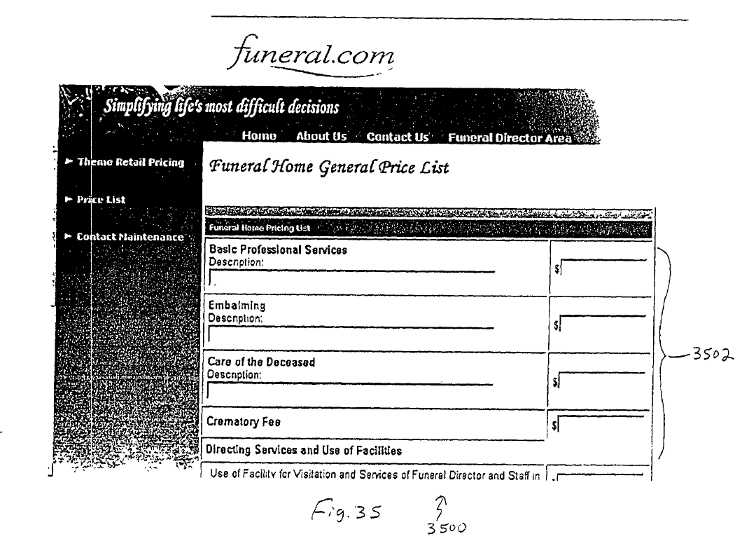

The content may be entered into a general pricing list (GPL) standardized form provided by the web servers. The information in this standardized form is then transferred to the GPL database 132 contained in the production server 110. An example of a GPL entry screen is shown in FIG. 35 as GPL page 3500 as provided by the funeral service provider paging module of FIG. 17. Various entry fields 3502 are presented for the FDM to enter information including the prices and descriptions.

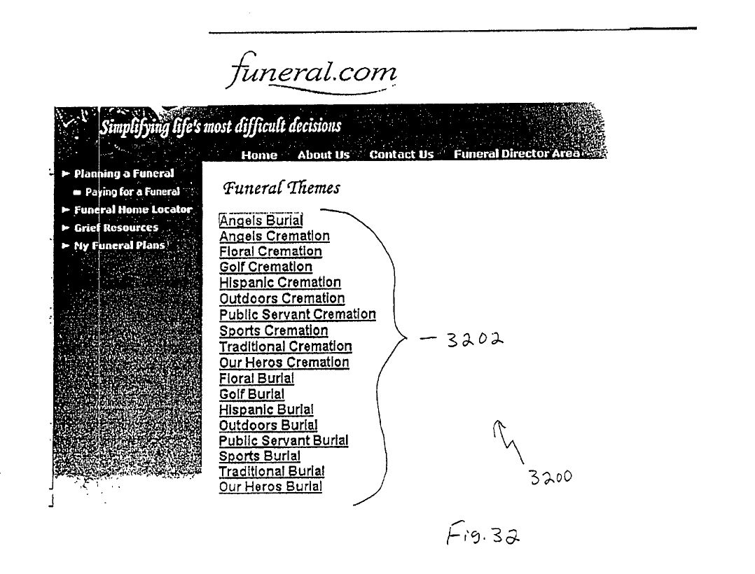

The FDM may then also choose to develop experience packages at option operation 208. An experience package, also known as a themed package, is a grouping of products and services that are specialized based the interests or lifestyle of the deceased. An exemplary listing of themed packages available to a consumer is shown in FIG. 32 as theme page 3200 as provided by the consumer paging module of FIG. 20. Various themes 3202 are listed for selection by the consumer if the consumer chooses to purchase a themed package rather than making individual product and service selections.

At the option operation 208, the FDM chooses the service options for the package and associated prices for the service, and the products as discussed below are retrieved from the GPL database 132 to generate pricing totals for the packages. Rather than duplicating supply catalog 128 entries in the GPL database 132, links to the proper catalog entries in the supply database 128 may be contained within the GPL database 132 for products selected for sales by the FDM. Then, the FDM selects and prices any other service options not previously priced but offered through the virtual transaction site 100 to the consumer at option operation 214.

The FDM selects products to be offered to consumers from supplier catalogs in supply database 128 provided through the virtual transaction site 100 and sets price multipliers at products operation 206 to create retail prices from the suppliers' wholesale prices. The supplier catalogs provided from the product supplier devices to the virtual transaction site 100 are typically stored in the production server 110 and are provided to the funeral service provider devices 118 when setting up the microsite. The catalogs typically indicate the price available to the funeral service provider (i.e., wholesale price), and the funeral service provider then sets a multiplier for the products to increase the price of the product as it is offered to the consumer through the microsite (i.e., retail price). The products and associated multipliers for the funeral service provider are stored in the GPL database 132.

At package operation 210, the FDM selects the products chosen from the supplier catalogs and stored in the GPL database 132 to populate the pre-selected packages to be offered to consumers. The products for the pre-selected packages with prices are then stored in the GPL database 132. After the FDM has completed providing the funeral service provider content to the GPL database 132, the microsite with links to the funeral service provider content, such as the GPL, is published to the Internet at microsite operation 216. The transaction site provider lists the funeral service provider as an available vendor on the virtual transaction site at site operation 218. Although embodiments of the present invention are described as utilizing microsites, it is to be understood that microsites are optional and that funeral service provider pricing lists may alternatively be maintained in database form whereby consumers may select as an option to see the pricing sheet of the funeral home. Additionally, at virtual transaction site locations where consumers may view pricing, the pricing lists of multiple funeral homes may be displayed to enable the consumer to perform side-by-side comparisons.

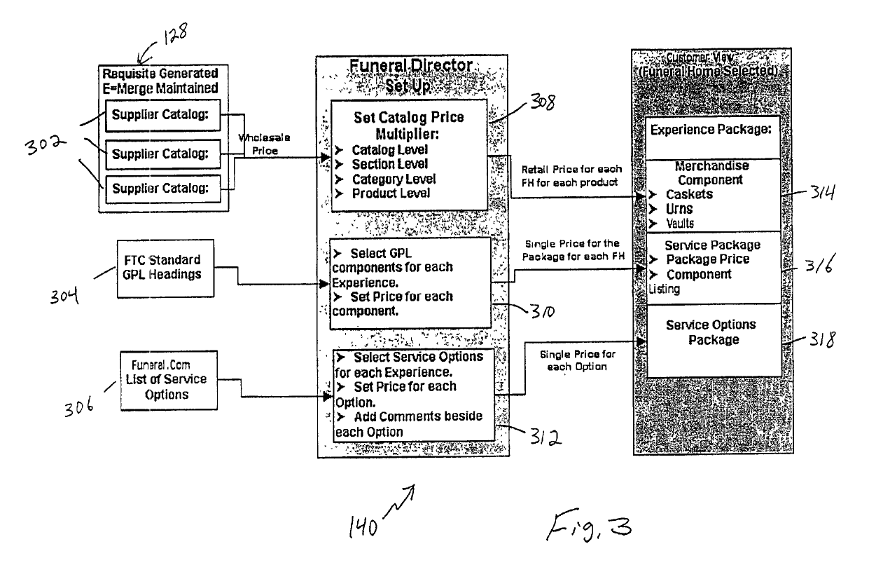

FIG. 3 shows the process of package pricing module 140 as specified by a funeral service provider microsite, or as contained in a funeral service provider pricing list. The production server 110 maintains supplier catalogs 302 in the catalog database 128 that show the products available from each supplier and the wholesale price that the funeral service provider must pay to obtain the products. The GPL standardized form for services is maintained by the production server 110 in the GPL database 132 and is provided to the funeral service device 118. The list of service options 306 typically offered through the virtual transaction site 100 are provided to the funeral service provider device 118 from the production server 110 as well.

The FDM sets up the microsite, as discussed with reference to FIG. 2, by setting catalog price multipliers at price operation 308. The price multipliers may be set for a catalog level where every product offered from a given catalog is multiplied by the same value. Alternatively, the price multipliers may be set by section of the catalog from which the products come, from the category of the products, or product-by-product. Furthermore, the price multipliers may be provided as a combination of these price multiplier options. In the alternative to the microsite, the pricing list of the funeral service provider may be similarly configured whereby the listed price results from a wholesale supplier price and a selected multiplier.

The GPL list is provided to the funeral service provider who selects the desired components to offer to consumers, as is shown in FIG. 35, at GPL operation 310. The FDM then sets up the price by entering the desired multiplier desired for each component selected from the GPL and selects additional service options 306 suggested by the virtual transaction site 100 at option operation 312. The FDM may then set a price for each service option and add comments that will be provided to the consumer when choosing the options to purchase.

The retail price for each product, resulting from the price multiplier, is provided to the consumer who chooses through transaction site navigation implemented by the consumer paging module of FIG. 20 to view an experience package at operation 314. The products shown in FIG. 3 at operation 314 are for exemplary purposes. The service packages, as specified through the GPL by the FDM, are provided at operation 316 to the consumer selecting to view an experience package, examples of which are shown in the exemplary screen display of FIG. 32. The service package options, as suggested by the transaction site provider, may be provided to the consumer at operation 318. Thus, the consumer may opt to purchase an experience package having pregrouped product packages, service packages, and additional service options and thereby eliminate many decisions.

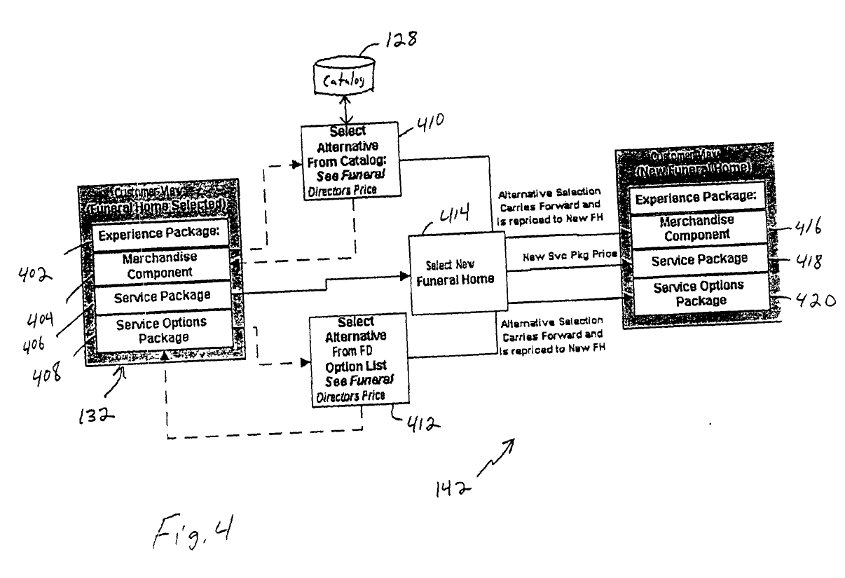

FIG. 4 shows an experience package data structure process of package modification module 142. Typically, this module is implemented when the consumer cannot find a satisfactory experience package and wishes to customize the experience package 402. The experience package 402 initially has a merchandise component 404 consisting of a product package, a service package 406, and a service options package 408, all of which are to be provided by a chosen funeral service provider, such as a funeral home.

The consumer may view the experience package 402 through the consumer paging module of FIG. 20, and then at product operation 410, elect to substitute products from a supplier catalog stored in the catalog database 128 of the production server 110 in place of preselected products included in the experience package 402. The web server 106, 108 provides the product options of interest from the supplier catalog of database 128 to the consumer but provides the retail price (i.e., wholesale price from the catalog scaled by the price multiplier selected by the funeral service provider for the experience package selected). The consumer selects the substitute products and they are included in the modified merchandise component 404.

The consumer may opt to modify the service package by selecting a different funeral home to provide the funeral service at service operation 414. The selection of a funeral service provider is generally restricted by geographical location of the provider. Selecting a different funeral service provider than the one originally associated with the experience package 402 causes the consumer paging module of FIG. 20 to display a new service package 418 with different pricing on the consumers display device 116. This selection also causes the pricing for the product package 416 and service option package 420 of the experience package 402 to be modified according to the new funeral service provider's pricing scheme.

The consumer also may opt to modify the service options package 408 for the experience package 402 by selecting alternative service options from the service option list at service operation 412. The service option list shows to the consumer the set of service options as provided by the virtual transaction site to the funeral service provider for selection during microsite creation. However, the pricing associated with the service option list shown corresponds to the pricing scheme set up by the funeral service provider. When the consumer opts to select a different service package by selecting a new funeral service provider, the consumer may wish to alter the service option package for the new funeral service provider as well at service operation 412, which then alters the service options package 408.

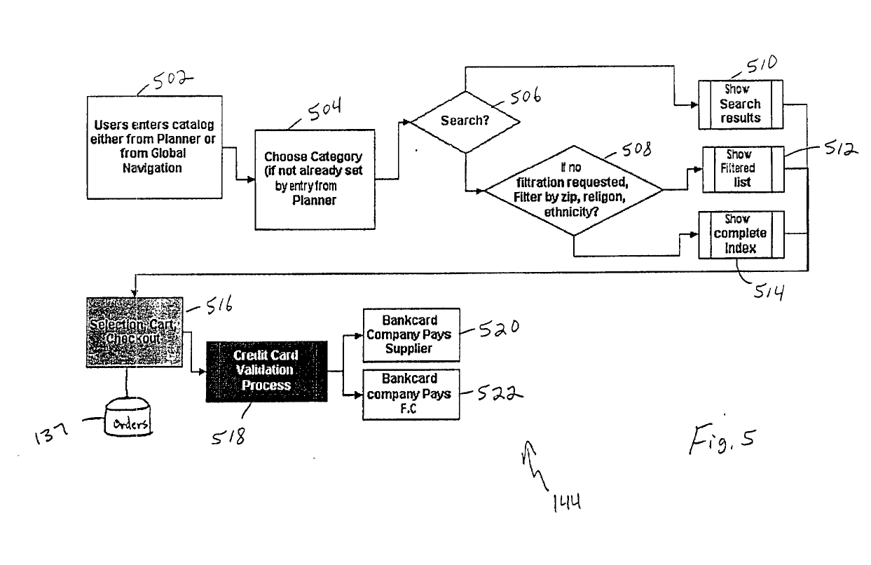

FIG. 5 shows the transactional process of the consumer purchase module 144 within the virtual transaction site 100 for a consumer purchase. The consumer enters a catalog of selections from either a planner, discussed below, or from global navigation of the consumer paging module of FIG. 20 for the virtual transaction site 100 at entry operation 502 (such as to a microsite or pricing list). The consumer then chooses a category at selection operation 504, unless the category is already selected by the planner. Query operation 506 then detects whether the consumer has initiated a product or service search in the catalog category.

If the consumer does initiate a search, then the results of the search are provided from the web server to the consumer's display at operation 510. If the consumer does not initiate a search, then query operation 508 tests whether the consumer has applied filtration for the category based on geographical location (i.e., zip code entry), religion of the subject of the funeral, ethnicity of the subject of the funeral, etc. The list of products are contained in catalog database 128 and the list of funeral service providers are contained in GPL database 132 such that identifiers for each can be sought by the CPU 122 of the production server 110 to find matches based on the filtration or search parameters. If the consumer did apply filtration, then a filtered list is provided from the web server to the consumer's display at operation 512. If no filtration was applied, then the complete index for the category is provided from the web server to the consumer's display at operation 514. The process could employ filtration where the consumer has initiated a search as well.

After displaying the options within the category to the consumer, the consumer makes option selections for the desired items for each funeral service option, typically loads them to a virtual shopping cart, and then proceeds to a virtual checkout provided by the consumer paging module of FIG. 20 where the purchase is confirmed at buy operation 516. At this point, the consumer ID and purchase information is stored in Order database 137. The virtual transaction site 100 is typically set up to handle payment through a credit card transaction.

The consumer must enter credit card information during the checkout process. The credit card information is validated at card operation 518 through standard electronic procedures and communications. The company for the credit card used is provided the transactional details through standard electronic communications and is expected to pay the supplier of the product or service, which is the funeral service provider in most instances, at pay operation 520. The transaction may be divided into two parts, one for the cost of the purchase and one for any cost of the consumer or FDM using the virtual transaction site 100, so that the company for the credit card is expected to pay the transaction site provider for the use of the virtual transaction site at pay operation 522.

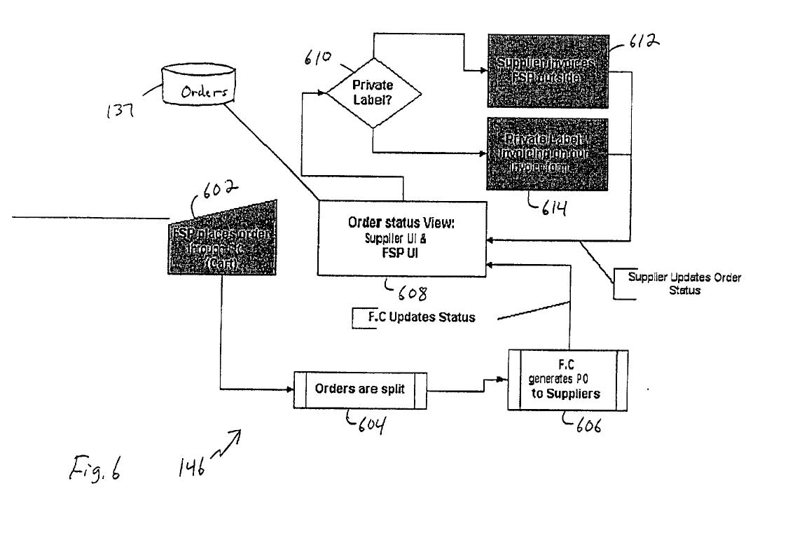

FIG. 6 shows the transactional process of the FDM product purchase module 146 for the funeral service provider ordering products to be utilized in providing the funeral service through the virtual transaction site. Product suppliers have registered their catalog of products with the virtual transaction site and these products are available for selection by the funeral service provider The virtual transaction site utilizes the process illustrated in FIG. 5 for purchases by the funeral service provider, but the products are accessed from the catalog database 128 for product suppliers and payment for purchases goes to the product suppliers and the transaction site provider.

The transactional process of FIG. 6 begins by the funeral service provider placing an order through the virtual transaction site (F.C.) shopping cart as discussed with reference to FIG. 5 at cart operation 602. The orders are divided into sets of products that are being purchased from a given product supplier at order operation 604 The transaction site provider generates purchase orders that are then disseminated to each of the product suppliers corresponding to the products ordered at supplier operation 606. The transaction site provider then updates order status maintained by the order database 137 of the production server 110 to indicate that purchase orders have been sent. The order status is provided by the web servers 106, 108 to the funeral service provider device 118 or the supplier device 120 at display operation 608 if either chooses to view the order status through the virtual transaction site 100.

Query operation 610 then tests whether each product that has been ordered is from a private label. If so, then the invoicing is generated and disseminated for the private label by the transaction site provider at invoice operation 614. Then, the transaction site provider updates the order status in the order database 137 of the production server 110 to indicate upon display of the order status that invoicing is complete at display operation 608. If the label is not private, then the supplier may invoice the funeral service provider directly at invoice operation 612. Then, the supplier updates the order status by navigation in the virtual transaction site 100 through the supplier paging module of FIG. 19 to communicate with the web server 106, 108 that then provides the update to the order database 137 of production server 10 to indicate upon display of the order status that invoicing is complete at display operation 608.

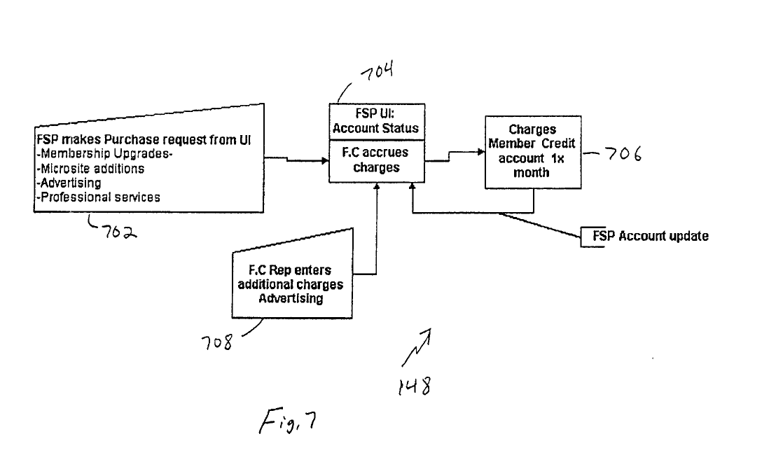

FIG. 7 shows the transactional process the FDM transaction site purchase module 148 for a funeral service provider purchasing service from the transaction site provider to enable the funeral service provider to market its products and services to consumers through the virtual transaction site 100. The funeral service provider makes a purchase request from the virtual transaction site 100 at purchase operation 702. The purchase request may be for a membership, a membership upgrade, an addition to a microsite, advertising, professional services, etc. The transaction site accrues the charges for the purchase at status operation 704.

At this operation, the account status for the funeral service provider is updated to indicate the amount owed based on the purchase price. A representative of the virtual transaction site may interact with the virtual transaction site 100 to update the status at representative operation 708. This interaction may be necessary for purchases such as additional advertising where the funeral service provider must pay additional charges for reasons such as the size of the desired advertisement, etc. that cannot easily be taken into account through automated procedures.

The charges for the amount owed according to the account status are then billed to the credit account on a periodic basis through standard electronic communication procedures by the virtual transaction site 100 at credit operation 706. After each payment of the periodic charge by the credit company for the funeral service provider, the account status is updated in the membership database 136 at status operation 704 to reflect the payment.

FIG. 8 shows the process of the registration module 150 for funeral service providers as well as product suppliers registering for usage of the virtual funeral transaction site 100. The registrant completes an on-line application, accessible through one or more pages provided by the paging module shown in FIGS. 16-29, and submits the application to the production server through the web server at application operation 802. Query operation 804 detects whether the registrant has been preapproved as a member based on criteria set up by the transaction site provider and maintained by membership database 136. If the registrant has been preapproved, then preapproval data, such as data maintained by funeral director, industry, or other associations may be retrieved by the virtual transaction site 100 from network accessible resources or otherwise. This data may be considered by transaction site provider representatives at operation 808 to manually approve the registrant if necessary.

Registrants that are not preapproved will be considered by a transaction site provider representative at operation 808 to determine whether approval is appropriate based on the application information previously provided. After registrants have been approved, a preexisting registration for the registrant may be updated at operation 812. The period of grace for payment of transaction site charges that is set up for preapproved registrants is tested at query operation 810. If the period of grace is correct based on the registrant's application information, the credit card of the registrant is validated at card operation 814. If the period of grace is not correct, the registration is updated at operation 812 to correct the period of grace.

After the registration has been updated or the credit card has been validated, the membership data for the registrant is updated/created in the membership database 136 of the production server 110. This includes assigning an authentication code that the member uses to access the portion of the transaction site dedicated for his type of services. The authentication code is discussed in more detail below with reference to FIG. 16. After updating the registration, the microsite for each registrant is created and published at microsite operation 818. A confirmation email may be sent to the registrant to confirm membership and to provide information regarding amending the microsite or other microsite information at notification operation 820.

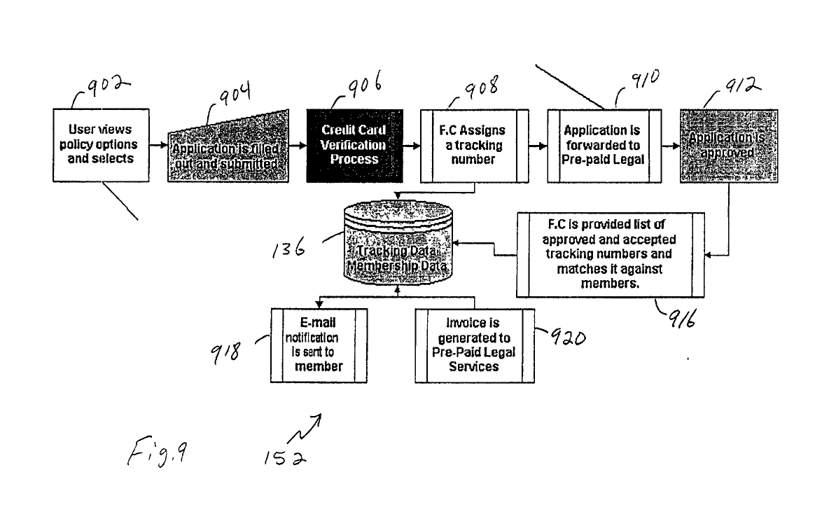

FIG. 9 shows the transactional process of pre-need legal module 152 for consumers obtaining prepaid legal service associations through the virtual transaction site 100. The member views the prepaid legal service policies and selects a policy through the virtual transaction site at policy operation 902. The member then fills out an on-line application at operation 914 provided by the consumer paging module of FIG. 20. The credit card of the member is verified at card operation 906. The virtual transaction site 100 then assigns a tracking number to the consumer which is stored in the membership database 136 of the production server 110 at tracking operation 908.

The application for the member is forwarded, typically through a network connection and a file transfer protocol or email, to the prepaid legal service at transmit operation 910. The application is reviewed by the prepaid legal entity at operation 912. If approved, the approved tracking numbers are transmitted back to the virtual funeral transaction site at operation 916 for each approved member. The cpu 122 of the virtual transaction site 100 then matches the approved tracking numbers against the associated members stored in the membership database 136. The approved members receive confirmation that they have been approved at notification operation 918, and the prepaid legal service is invoiced for use of the virtual transaction site 100 at operation 920.

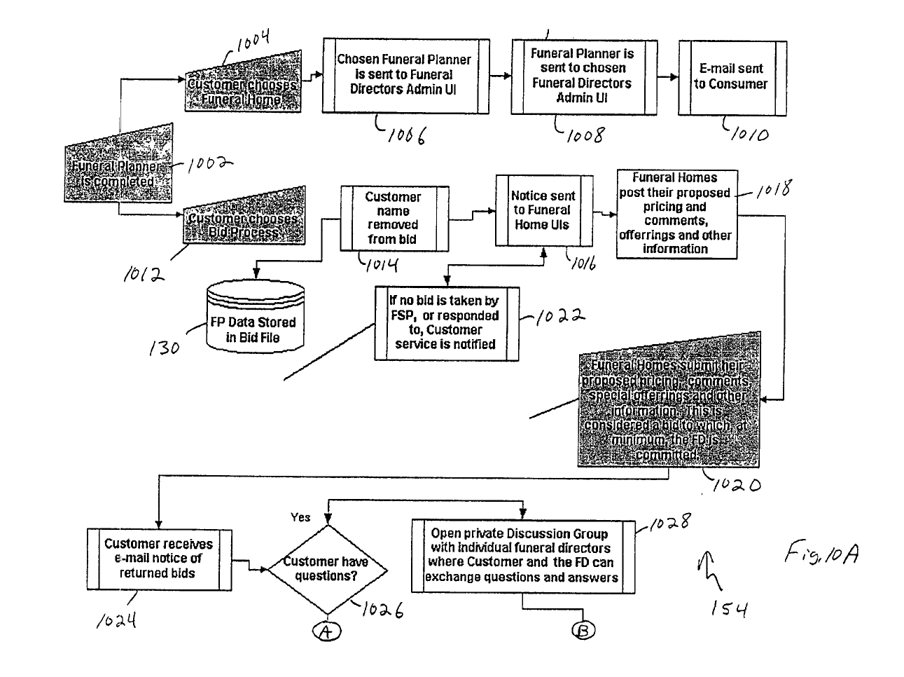

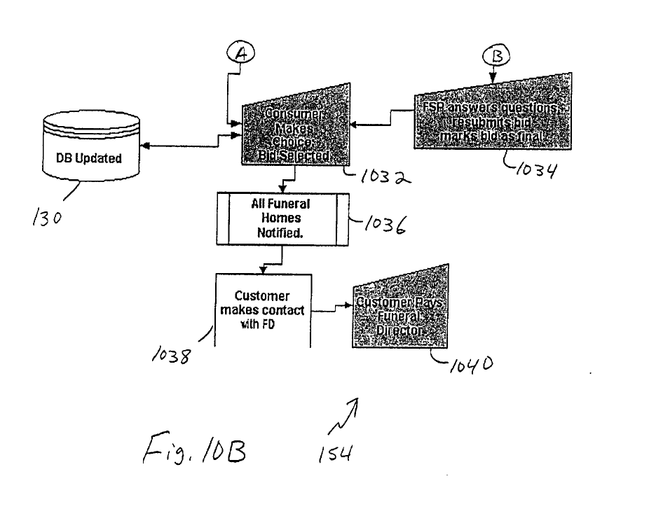

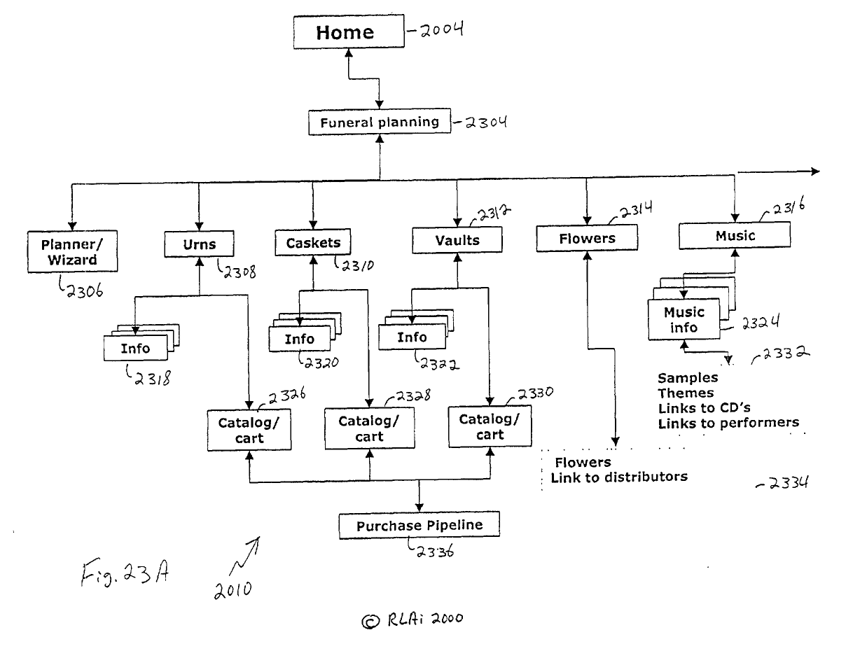

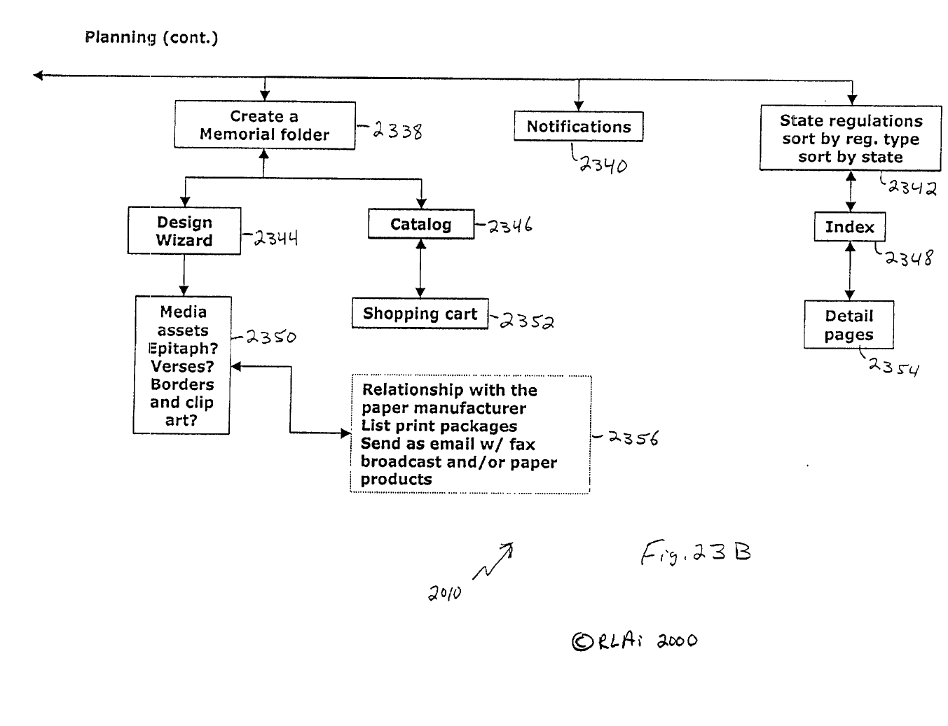

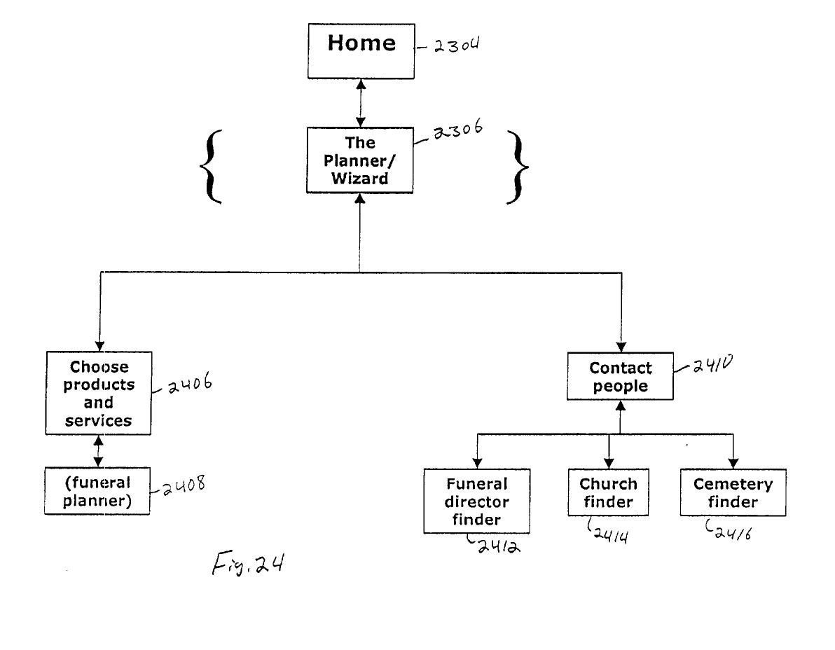

FIG. 10A illustrates a first portion of the transactional process resulting from the consumer's utilization of the funeral planner module 154 provided by the consumer paging module of FIG. 20 for the virtual transaction site 100. The funeral planner, as discussed below with reference to FIGS. 23A-24, guides the consumer through the funeral planning process by providing a predetermined set of steps that the consumer follows to plan the funeral. The funeral planner gives the consumer the option to plan a funeral based on the content previously provided by a chosen funeral home that includes pricing information disclosed to the consumer, such as through the microsite or pricing list of the GPL database 132. In another mode of operation, as shown in FIGS. 10A and 10B, the consumer completes the funeral planner process at operation 1002 and the pricing scheme is determined after the plan set up is disseminated to the funeral service provider(s).

After completing the funeral planner in this mode of operation, the consumer may be provided an option to select a funeral home to execute the funeral plan at operation 1004 and an option to utilize a bid process to attempt to obtain the best price at operation 1012. If the consumer chooses to select the funeral home, the funeral planner set up is delivered to the funeral director's administration page of the funeral service provider paging module of FIG. 17 that is provided by the virtual transaction site 100 at operation 1006. The funeral planner setup is populated by the prices from the funeral service providers stored GPL in GPL database 132, and possibly after authorization is provided by the funeral director from the administration page at operation 1008. An email to confirm the acceptance of the plan and the pricing is then delivered to the consumer at notification operation 1010.

If the consumer chooses to utilize the bidding process, the customer's identification is stripped from the bid (plan setup) for funeral service at name operation 1014 by production server 110. The plan setup data is then stored in a bid file for the consumer in a bid database 130 maintained by the production server 110. A notice of the bid is then sent to the funeral home sites maintained by the virtual transaction site 100 in GPL database 132 that are reviewed by the funeral home operators. Funeral homes that are interested in the bid then provide a return bid consisting of proposed pricing, comments, offerings, and any other information of interest to the virtual transaction site 100 at operation 1018. The proposed bid is submitted by the virtual transaction site 100 via email to the consumer at operation 1020.

If no funeral service provider returns a bid, then the virtual transaction site 100 will notify the transaction site provider so that customer service can determine whether a problem in submitting the customer's bid occurred or whether the bid was unacceptable by all available funeral service providers at service operation 1022. Customer service can then determine whether the bid should be resubmitted or whether the consumer should simply be notified that no return bids were generated.

Once the consumer receives the return bids at notification operation 1024, query operation 1026 detects whether the consumer replies to the virtual transaction site 100 with questions via email or through the consumer paging module of FIG. 20. If so, the virtual transaction site 100 opens an on-line discussion group between each funeral director and the consumer to facilitate the exchange of questions and answers without requiring conventional meetings between the consumers and funeral directors at operation 1028. After the consumer has questioned the funeral directors, they may resubmit bids based on any new understandings or selections at bid operation 1034 of FIG. 10B.

If query operation 1026 detects that the consumer has no questions, then the consumer submits a bid choice at operation 1032 of FIG. 10B. The bid file in bid database 130 is updated to reflect the selection. All funeral homes who returned bids are notified of the selection at operation 1036. The consumer is expected to contact the funeral service provider directly to work out remaining details, if any, at contact operation 1038 such as through email or ordinary forms of communication. The customer is then expected to pay the funeral director through the agreed upon means at operation 1040.

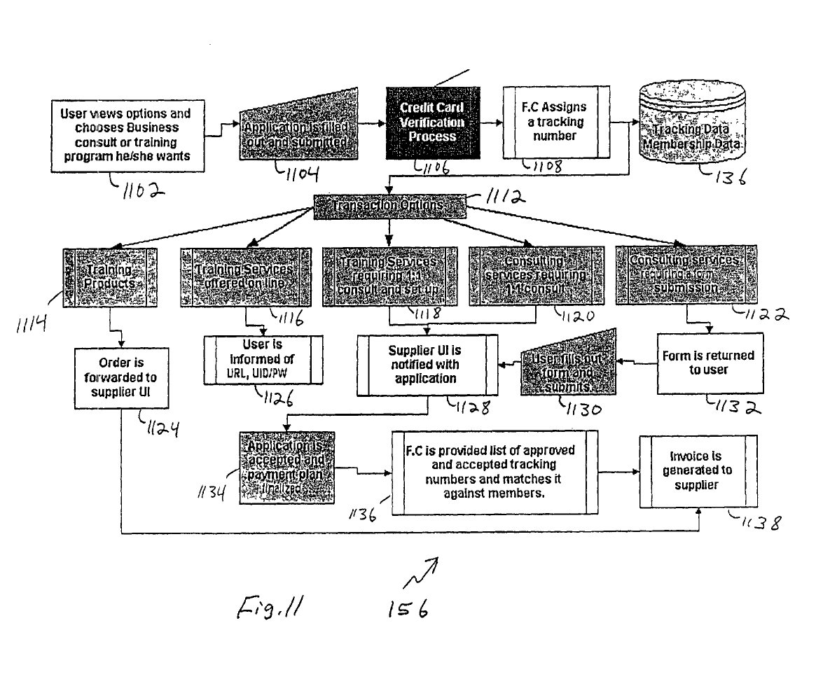

FIG. 11 shows the transactional process of a training and consulting module 156 that may be provided. The member chooses the desired consulting or training program that is offered by the virtual transaction site 100 at operation 1102. The member submits an application for the program at operation 1104. The credit card of the member is verified at operation 1106 through standard electronic procedures. The virtual transaction site 100 assigns a tracking number to the member's application. The tracking number is stored in the membership database 136 maintained by the production server 110.

The virtual transaction site 100 then detects the appropriate transaction option 1112 based on the selected program. For training products 1114, the virtual transaction site 100 forwards the order to a supplier at operation 1124 and generates an invoice to the supplier at operation 1138. For training services 1116 that are offered on-line, the virtual transaction site 100 sends notification to the member at operation 1126 of the appropriate URL, ID, and password necessary for obtaining the training service.

For training services 1118 and consulting services 1120 that require a one to one consultation, the virtual transaction site 100 notifies the supplier site with the application provided by the member at operation 1128. Similarly, for consulting services 1122 requiring a form submission, a form is returned to the member via email or otherwise at operation 1132. The member completes the form and returns it via email or otherwise at operation 1130, and then the virtual transaction site 100 notifies the supplier with the application and form at operation 1128.

After notifying the supplier, the supplier accepts the application and finalizes the method of payment for the member at operation 1134 and each supplier provides a list of approved tracking numbers to the virtual transaction site 100 at operation 1136. The virtual transaction site 100 then generates an invoice to the supplier at operation 1138 that may be delivered by email or other standard means of communication.

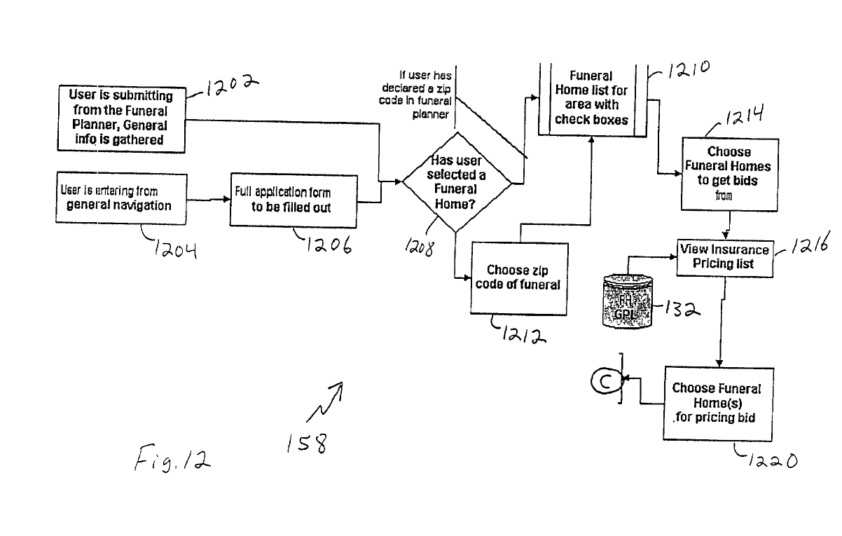

FIG. 12 shows the consumer portion of the transactional process for obtaining pre-need funeral insurance through pre-need insurance module 158. The consumer may submit an application for insurance from the funeral planner of the consumer paging module of FIG. 20 at operation 1202. The consumer also may submit an application for insurance by entering the insurance application page from general navigation, through the consumer paging module of FIG. 20, of the virtual transaction site 100 at operation 1204. If entering from general navigation, information normally obtained in the funeral planner process must be obtained for a full application submission at operation 1206.

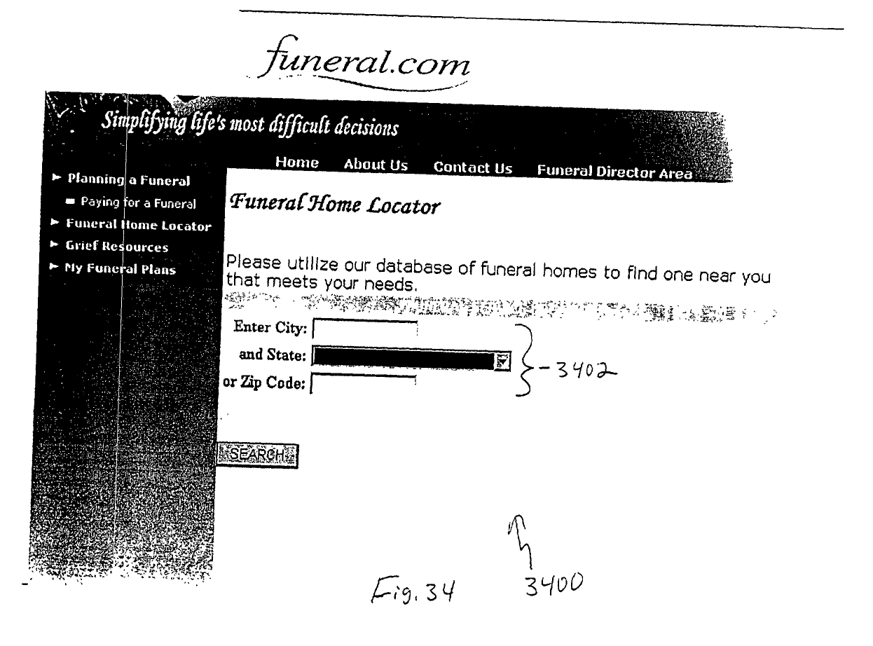

After submission of the application, query operation 1208 detects whether the consumer has selected a funeral home or zip code or other geographical information for the funeral home. An example of the screen provided to consumer devices 116 for determining the appropriate funeral home is shown in FIG. 34. The consumer enters the city, the state, and/or the zip code through entry fields 3402 if the consumer wishes to search for a funeral home. If the consumer has entered the geographical information for the search, then a list of funeral homes of the area is provided at display operation 1210. If not, then zip code operation receives a zip code from the consumer and then display operation 1210 provides the list of funeral homes for the area. The consumer then selects the funeral homes that insurance bids should be received from at operation 1214. The virtual transaction site 100 then provides a pricing list for the insurance for the funeral homes selected at operation 1216 by retrieving the pricing information from the GPLs in the GPL database 132 for the funeral home having GPLs stored therein. The consumer then selects the funeral homes that are to price the bid for the consumer's plan at operation 1220.

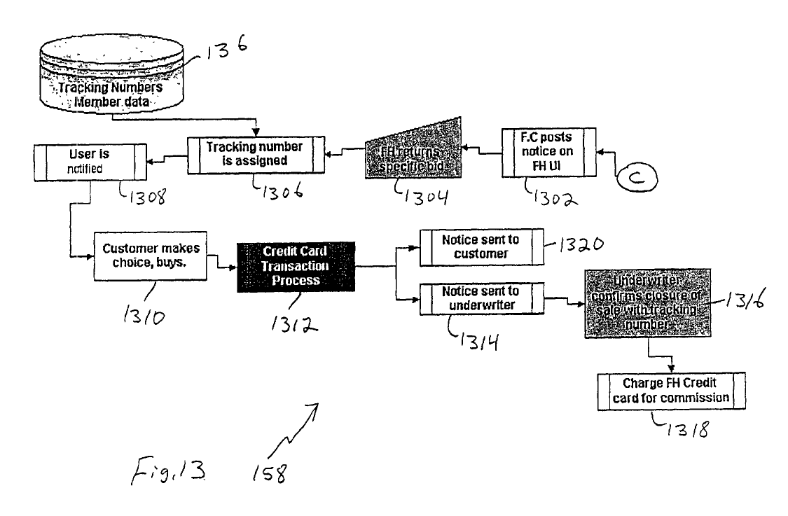

FIG. 13 shows the funeral home portion of the pre-need funeral insurance transaction process of pre-need insurance module 158. The virtual transaction site 100 provides a notice of the bid to all funeral homes selected by the consumer at operation 1302 through email or other conventional communications. Each funeral home that is interested returns a bid to the virtual transaction site at operation 1304. The virtual transaction site then assigns a tracking number from the membership database 132 maintained by the production server 110 to each return bid. The consumer is then notified of the return bids at operation 1308.

The consumer chooses a return bid and purchases it at buy operation 1310. At card operation 1312, the credit card of the consumer is verified and charged, and a notice of the purchase is provided to the consumer at operation 1320. A notice of the purchase is also provided to the associated underwriter at operation 1314. The underwriter may confirm the sale by electronically replying to the virtual transaction site 100 with the assigned tracking number at operation 1316. The virtual transaction site 100 then charges the credit card of the funeral home for commission in facilitating the sale at operation 1318 through standard electronic procedures.

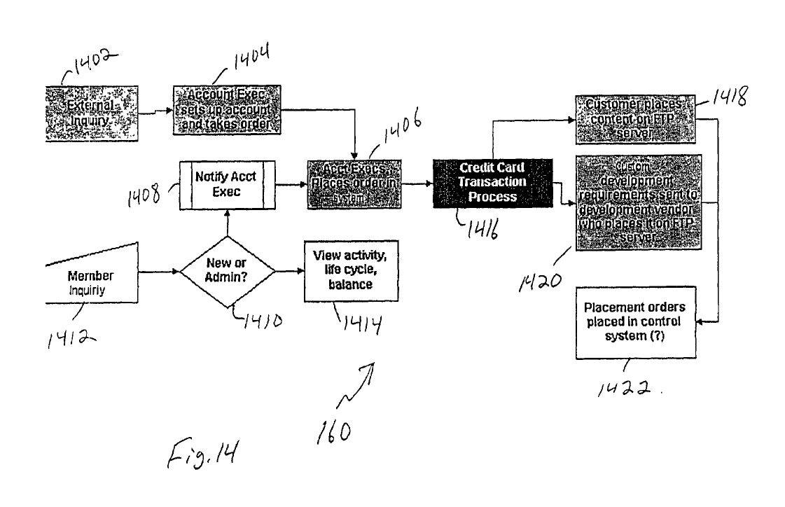

FIG. 14 shows the transactional process of the advertising purchase module 160 for funeral service providers and product suppliers placing advertisements on the virtual transaction site 100. If a non-member wishes to place advertisements on the virtual transaction site 100, an external inquiry is placed at operation 1402. The inquiry is received by an account executive of the virtual transaction site 100 who then sets up the account and takes the advertising order at operation 1404 through ordinary means of communication.

If a member wishes to perform an advertisement transaction on the virtual transaction site 100, the member sends an inquiry at operation 1412. Query operation 1410 detects whether the inquiry deals with placing a new advertisement or an administrative function for an existing advertisement. If the member wishes to perform an administrative function, the member may view the activity of the advertisement (i.e., number of pages containing the advertisement, the duration remaining for the advertisement, etc.) at display operation 1414 through navigation of one of the paging modules shown in FIGS. 16-19.

If a member wishes to place a new advertisement, an account executive is notified at operation 1408 by the production server 110. The account executive then places the order for the advertisement into the virtual transaction site's queue for rendering advertisement content on various pages of the virtual transaction site 100. The credit card of the party placing the advertisement is then charged at card operation 1416. The party placing the advertisement then electronically transfers the content files, if available, to a web server 106, 108 to be stored where it can be accessed by the web server 106, 108 of the virtual transaction site 100 at operation 1418.

If the content is not available, the custom requirements for the advertisement are provided to the virtual transaction site 100 through email or other electronic communication provided by a paging module of FIGS. 16-19 where it is distributed to a development vendor at operation 1420 who then places the content on a web server 106, 108. The advertisement orders are then queued in the virtual transaction site 100 control system inplemented by CPU 122 to instruct the web servers to provide commands to browsers surfing the virtual transaction site 100 that causes the browsers to display the advertisement content at system operation 1422.

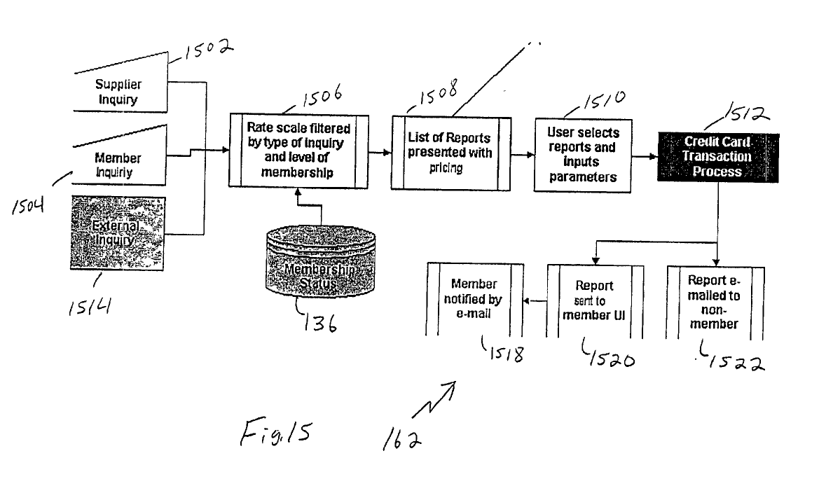

FIG. 15 shows the transactional process of the report purchase module 162 for obtaining virtual transaction site reports. A report inquiry from a supplier 1502, from a member funeral service provider 1504, or from an external party 1514 may be received from paging modules of FIGS. 16-19. The rate to charge the inquiring party is determined at operation 1506 by referencing membership status from membership database 136 of the inquiring party as well as the type of inquiry. The list of available site reports and pricing for each is displayed at report operation 1508 through a paging module. Reports may include site traffic, advertising usage, demographic data, and other data regarding usage of the virtual transaction site 100.

The inquiring party selects the desired report and inputs the necessary parameters for generating the report at operation 1510. The credit card of the inquiring party is charged at card operation 1512 through standard electronic procedures. The virtual transaction site 100 then sends the report via email to non-member inquiring parties at operation 1522. The virtual transaction site 100 publishes the report at the administrative site of the inquiring member at operation 1520 and sends a notification email to the inquiring member regarding the report at operation 1518.

FIGS. 16-31 illustrate the page layout of the virtual transaction site. The virtual transaction site 100 may be embodied as a web site within the world wide web accessible through the Internet 102. Such an embodiment provides static and dynamic web pages created through code such as HTML. The client devices of the consumer 116, funeral service provider 118, and product supplier 120 may then access the virtual transaction site 100 through a web browser The paging modules described below allow the client device to log in to the virtual transaction site, as shown in FIG. 16, by selecting the appropriate link. Then, as discussed below, the client device may access a password-protected collection of web pages, but the set of pages that are available depends upon type of entity that is logging. The password protection described below typically requests an authentication code from the party logging in, and this authentication code is searched within the membership database 136 to determine the level of access the party is entitled to may depend upon the registration. For example, consumers are limited to the pages provided by the consumer paging module of FIG. 20. Funeral homes are limited to the pages provided by the funeral service provider module of FIG. 17 This creates an extranet type of site whereby the transactions occur such that the consumers may not have direct access to the product suppliers' wholesale prices, and the product suppliers' may not have direct access to the orders received by a funeral home.

The paging modules described in FIGS. 16-31 are for exemplary purposes only. Other transaction site configurations are equally possible. Appendix A below includes a software requirements listing for exemplary paging modules of an embodiment setting forth typical input and output constraints. The paging modules may be maintained by secondary storage 126 of the production server 110 in the paging module database 134. The paging modules permit graphical information to be transmitted as electrical signals that are received and converted for display on client devices. The paging modules also permit client devices to transmit information as electrical signals back to the virtual transaction site 100. This transfer of information facilitates the implementation of the background processes associated with the modules of FIG. 1B.

FIG. 16 shows an overview map 1600 of the top-level paging modules provided by the funeral related virtual transaction site web site. Paging modules are sets of computer code, such as in HTML, XML, JAVA, etc. that permit information to be provided from the central database to the client device where it may be displayed and viewed and information may then be returned from the client device to the central database server. The paging modules set up various pages of information, such as web pages, that are displayed on the client device. A splash page 1602 is provided as an introductory page that may be provided to each party attempting to access the virtual transaction site 100. From the splash page, the party may select the appropriate link based on the type of transaction to be performed. The splash page provides an entry point to the virtual transaction site, which may be an extranet where consumers are given access to certain web pages, capabilities, and databases; where funeral home directors may be given access to a different set of web pages, capabilites, and databases; and where product suppliers may be given access to a thrid set of web pages, capabilites, and databases.

A consumer desiring to setup a funeral plan may enter the portion of the transaction site 100 set up for funeral planning by accessing a splash page link to consumer paging module 1604. Someone wishing to order flowers for a funeral may access a link to flowers paging module 1606 which would enable them to purchase flowers from member flower suppliers. Other direct links may be provided as well, such as to an obituaries page discussed below.

The splash paging module 1602 also may provide a link for product and service suppliers. A funeral home/funeral director may enter the portion of the transaction site setup for FDM transactions by selecting a link to FDM paging module 1608 to order products, place return bids, review consumer purchases, etc. A cemetery owner may enter the portion of the transaction site setup for cemetery transactions by selecting a link to cemetery paging module 1610 to update on-line plot selections, review FDM and/or consumer purchases, etc. A product supplier may enter a portion of the transaction site setup for supplier transactions by selecting a link to supplier paging module 1612.

FIG. 17 shows a structure of the next level of detail for the FDM paging module 1608. From the splash paging module 1602, the FDM selects the FDM paging module link and is provided a password entry field. The FDM then selects that the FDM wishes to register as a member or enters a preissued password if already a member. The FDM member is then provided a home page 1706. The home page 1706 then provides a selection into several sections tailored for the FDM.

The customized sections include a catalog section 1708 where the FDM can purchase products. The catalog section 1708 provides a finder tool 1710 that may assist the FDM in searching the catalog for the products of interest. The section also may provide a shopping cart 1712 that holds that selected items until the FDM is ready to purchase. A purchase pipeline 1714 is also provided to transfer the FDM's order to the production server and then submit the order to the associated suppliers, as previously discussed.

A flowers section 1716 is also provided to allow the FDM to select and purchase flowers that may have been requested by a consumer or that have been selected by the FDM for a particular funeral service. The purchase through the flowers section 1716 may proceed as discussed with respect to catalog purchases. The flowers section 1716 may be incorporated into the catalog section 1708 rather than being an independent option.

A cemetery finder section 1718 may be provided. This section allows the FDM to find cemeteries with plots that the FDM may wish to purchase for future sale or to satisfy a current consumer request. The cemetery finder also may provide plot maps for member cemeteries that allow the FDM to select a particular plot based on its location and availability.

A notification section 1724 may be provided. The notification section 1724 has two sub-sections, a section 1720 where the FDM may provide the notification of products, services, and the associated prices to be published on the pages in the consumer portion of the transaction site. This section is also associated with an accounting subsection 1722 where the prices set for products and service by the FDM are transferred to the production server for tabulation of costs for consumer selections. The other subsection is an obituary tool 1726 that permits the FDM to review existing obituaries. The obituaries tool 1726 also allows the FDM to review existing obituaries in the virtual transaction site as well as to electronically disseminate obituary notices to newspapers.

A pre-need insurance connections section 1728 is provided to allow the FDM to interact with pre-need insurance companies who write policies covering the costs of the funerals planned by consumers. The FDM may specify to the underwriter the costs of the products and services to be provided and may receive confirmation of the policy.

A classifieds section 1730 may be provided to allow the FDM to offer goods and services to other FDMs as welt as purchases goods and services offered by the other FDMs. This section may be broken into a product exchange section 1732 as well as an employment section 1734 allowing the FDM to post job openings and review the job openings of other member FDMs.

A training section 1736 may be provided to inform the FDM of schools, seminars, and other educational links and upcoming events. An industry information section 1738 may be provided to inform the FDM of industry publications, upcoming events and tradeshows, etc. A bulletin board section 1740 may be provided to permit the FDMs to post messages to other member FDMs and to form on-line discussions and chat rooms.

FIG. 18 shows a structure of the next level of detail for the cemetery paging module 1610. This map 1800 mimics the map 1700 for the FDMs, with access being provided from splash page 1602 through a password section 1804, except that the associated pages of the cemetery map may be geared to cemetery owners rather than funeral directors. The cemetery module provides access from a home page 1806 to the catalog section 1808 including the content finder 1810, the shopping cart 1812, and the purchase pipeline 1814. A link 1816 to flower suppliers is similarly provided or may be integrated into the catalog section 1808.

Rather than a cemetery finder, a funeral home finder section 1818 may be provided to assist the cemetery owner in seeking out funeral homes to offer plots or request service. A notification section 1820 includes subsection 1822 for posting sales information including products and prices in the consumer section. Subsection 1822 is again associated with accounting section 1824 to populate the production server with the products and prices used in tabulating the costs of consumer selections. An obituary tool 1826 is also provided to enable the cemetery owner to review existing obituaries and create and disseminate new obituary notices.

An insurance connections section 1828 is provided to allow the cemetery owner to communicate and/or confirm pre-need insurance coverage for plot purchases. A classifieds section 1830 is provided with a product exchange subsection 1832 and an employment subsection 1834, as was described for the FDM paging module. A training section 1836, industry information section 1838, and a bulletin board discussion section 1840 that may be tailored to cemetery owners are also provided.

FIG. 19 shows a structure of the next level of detail of the suppliers paging module 1612. The suppliers paging module 1612 provides a suppliers home page 1906 accessed from the splash page 1602 and through a password section 1904. The home page 1906 provides access to the catalog 1908. Rather than providing a purchasing mechanism for the catalog 1908 as was provided by the FDM and cemetery owner pages, the supplier page may be provided a catalog maintenance tool 1910. This tool allows the supplier to add or remove product offerings from the catalog as well as edit existing offerings.

A cemetery and funeral home finder section 1912 are provided to permit the supplier to determine members who may be targeted for advertising/marketing purposes. An insurance connections section 1914 may be provided as well to permit the supplier to find insurance companies who are writing policies through the virtual transaction site for similar advertising/marketing purposes. A classifieds section 1916 may be provided and broken into a product exchange section 1918 and an employment section 1920. The classifieds section provided for suppliers, cemetery owners, and FDMs may each be independent or they may be integrated into a single classifieds section accessible by all three member types. A training section 1922, industry information section 1924, and a bulletin board discussion section 1926 also may be provided and may be tailored for product suppliers or may be general as well.

FIG. 20 shows a structure of the next level of detail for the consumer paging module 1604. From the splash page 1602, the consumer then progresses to a home page 2004 where the consumer has several options. The consumer may globally navigate through all available sections, discussed below. The consumer may locally navigate to within the home pages 2004 to enter the location of the funeral that will be used in other areas of the consumer site, navigate through a genealogy section, review feature descriptions for the virtual transaction site, read news items, log in as a member, or log into a specific industry section of interest.

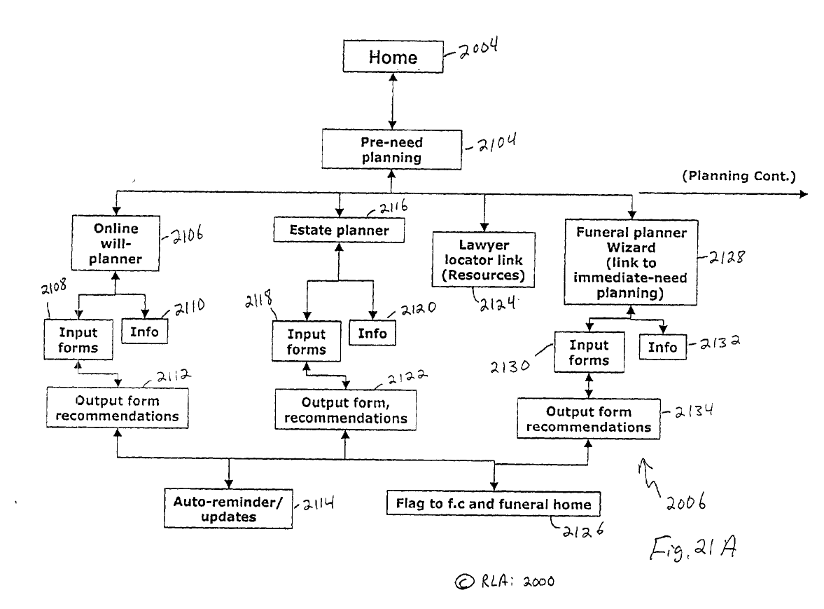

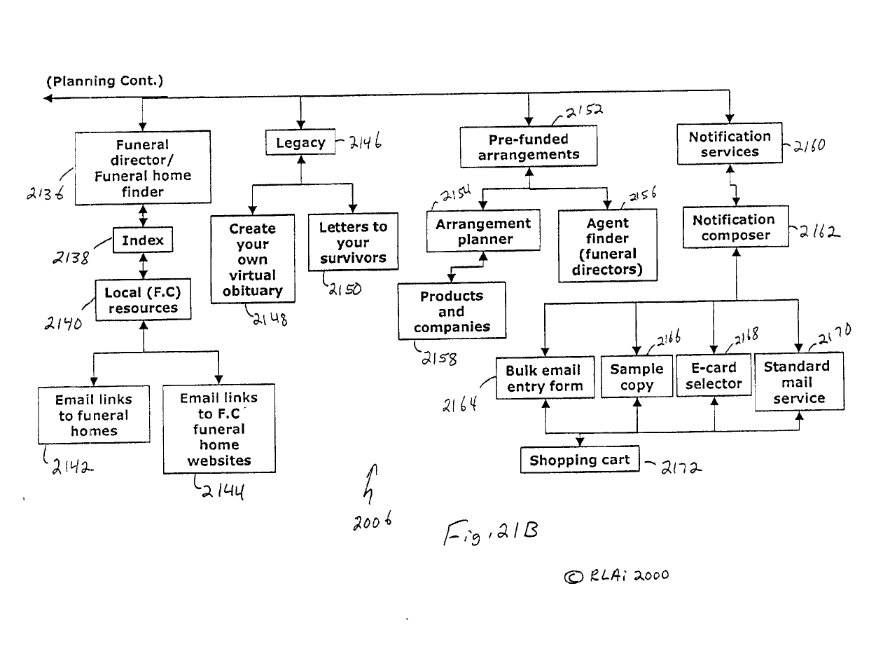

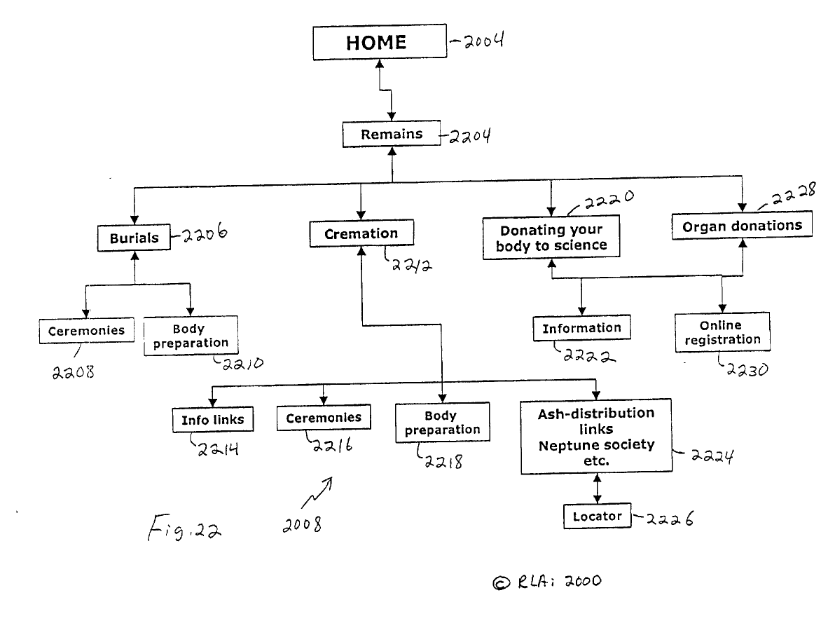

From global navigation, the consumer has several options. The consumer may choose to do pre-need planning, including planning the funeral itself, in section 2006 discussed in more detail with reference to FIGS. 21A and 21B. The consumer may choose to set up how the remains of the deceased will be handled, whether pre-need or immediate-need, at section 2608 described in FIG. 22. The consumer can choose to plan a funeral at section 2010 described in FIGS. 23A, 23B, and 24.

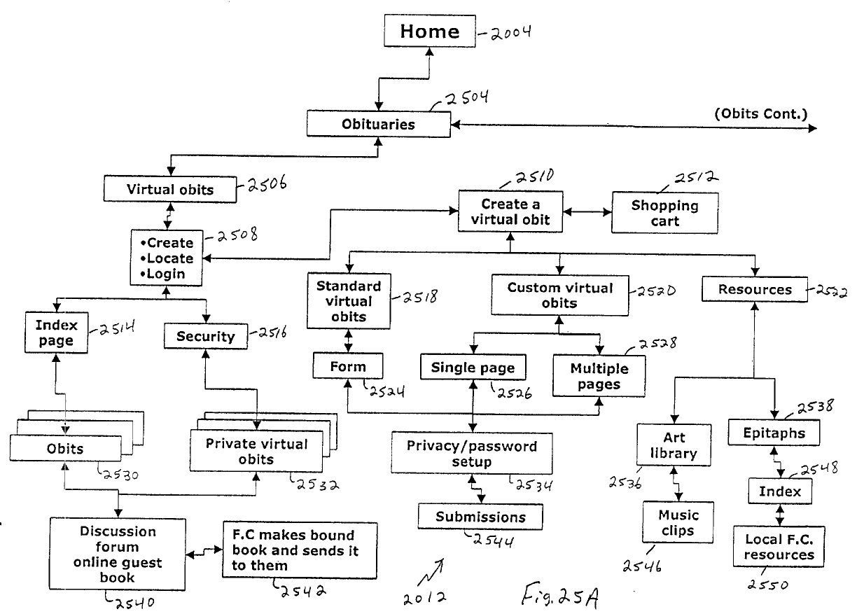

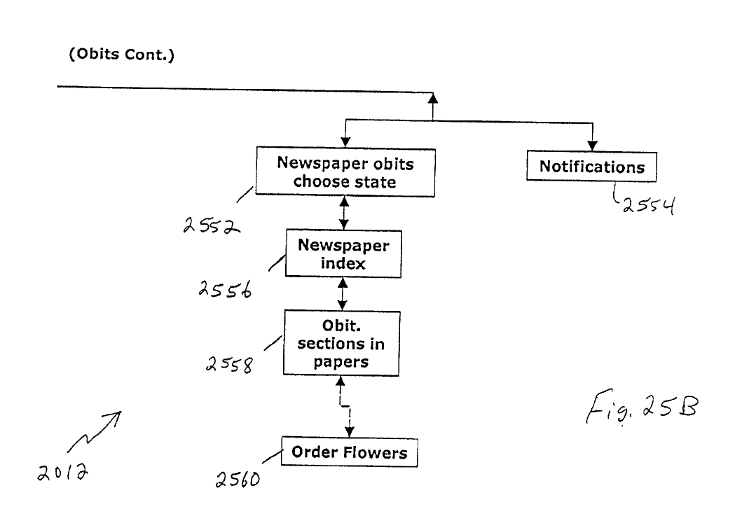

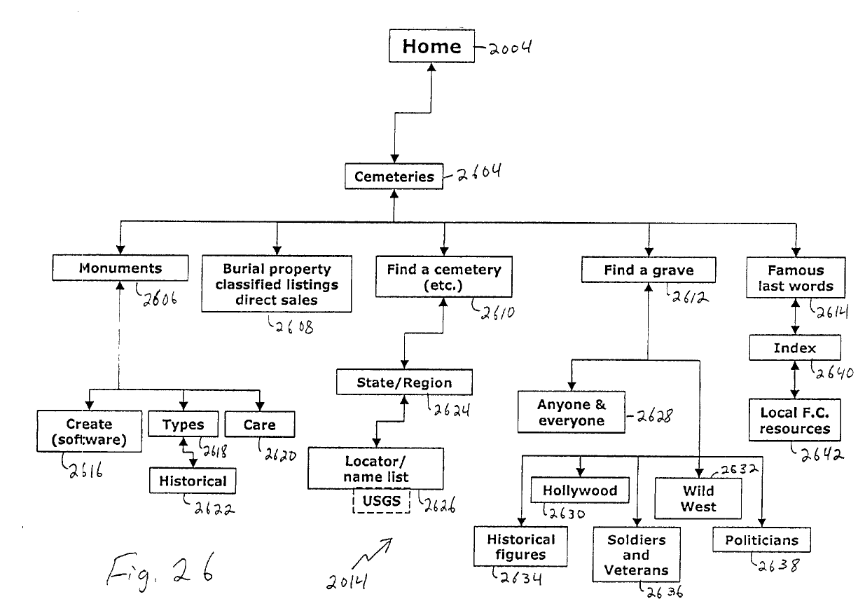

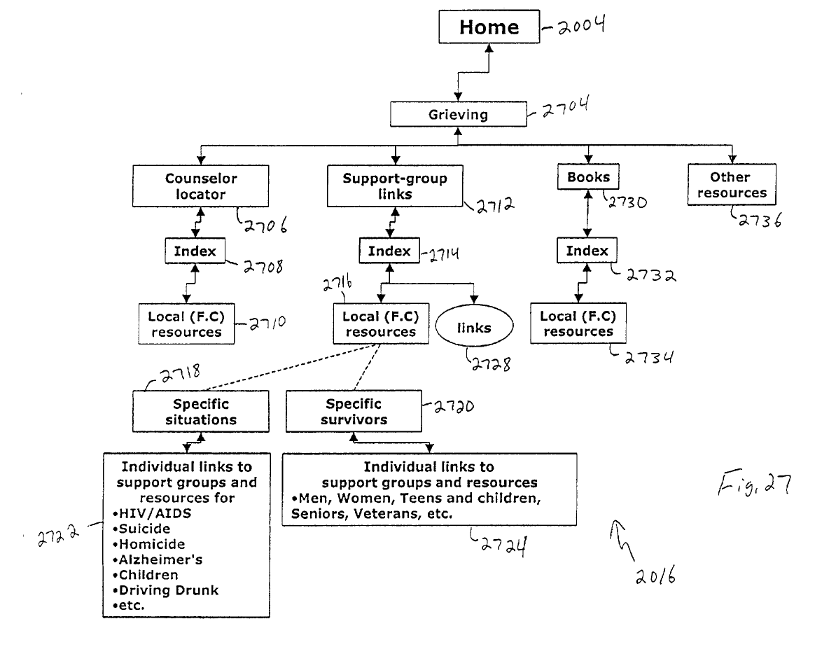

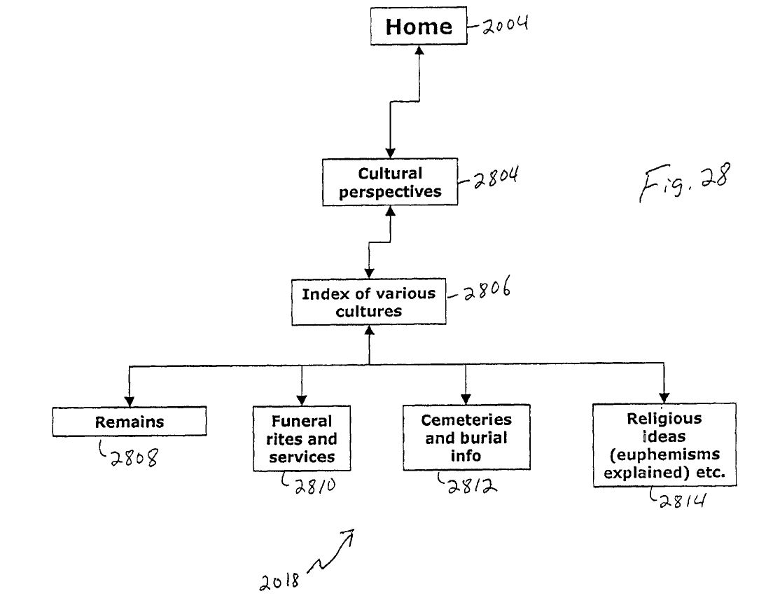

Other options provided to the consumer include the obituaries section 2012 shown in FIGS. 25A and 25B that allows consumers to read and place notices. A cemeteries section 2014, described in FIG. 26, is provided to allow the consumer to setup the burial on a pre-need or immediate-need basis. A grieving section 2016 of FIG. 27 is provided as a source of information for consumers dealing with death-related issues. A cultural perspectives section 2018, shown in FIG. 28, is provided as a source of information about various funeral rituals and traditions.

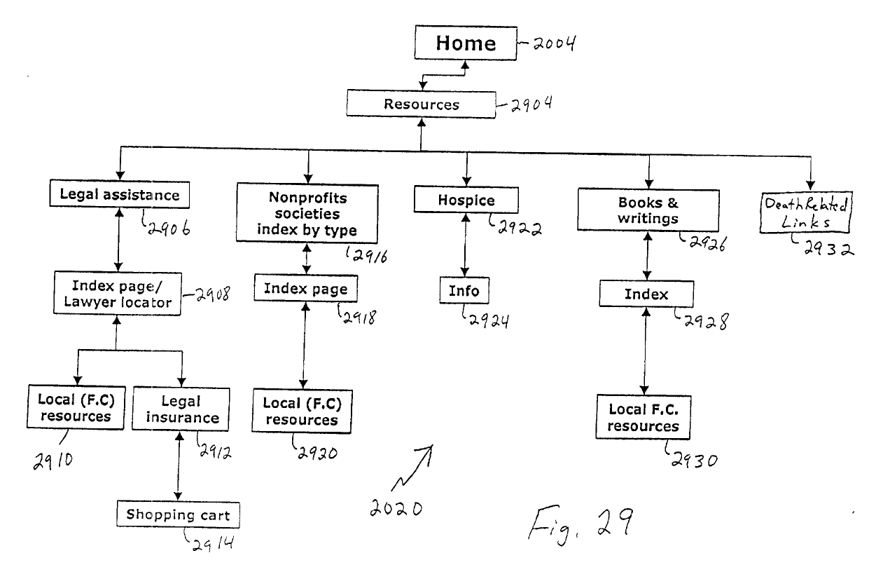

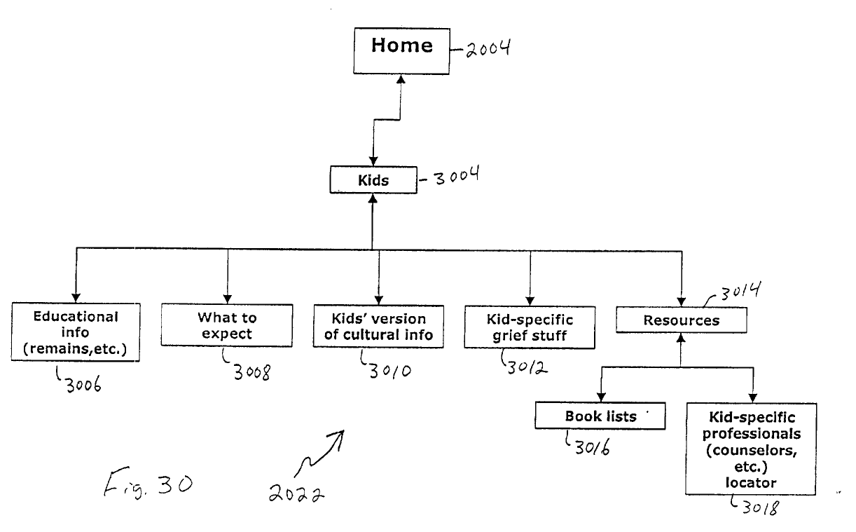

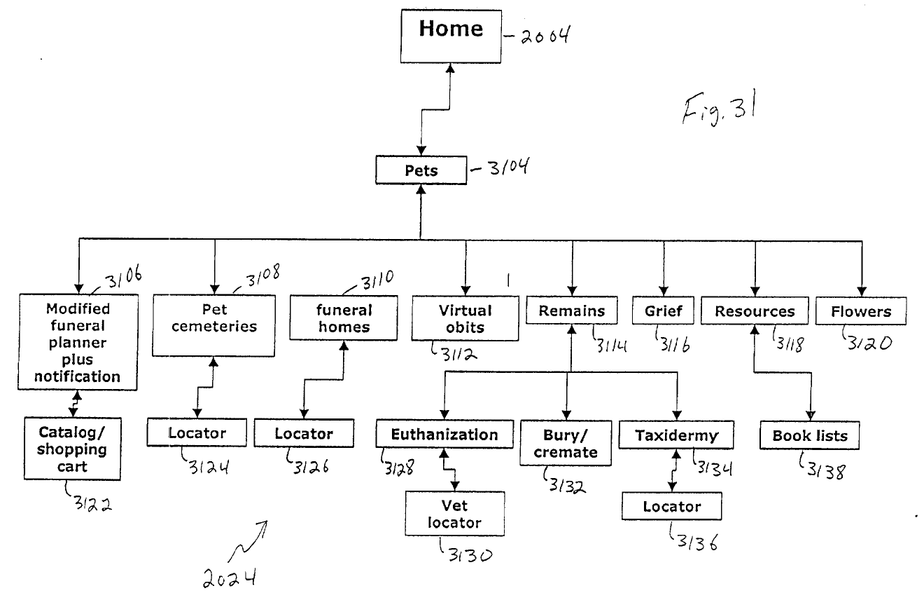

A resources section 2020 of FIG. 29 provides a source of information for consumers regarding collateral issues such as legal services, medical care, etc. A kids section 2022 of FIG. 30 is provided as a source of information for parents and children that seeks to assist children dealing with death related issues. A pets section of FIG. 31 is provided as a source of information for consumers seeking assistance with the death of a pet. A contacts section 2026 allows consumers to contact the transaction site provider regarding customer service, etc.

FIG. 21A shows a structure of the first portion of the pre-need planning sub-module 2006 shown as planning section 2104 linked from consumer home page 2004. The pre-need planning section 2104 provides several options. The consumer may choose the online will planner section 2106. Information regarding wills is provided by section 2110 and forms seeking input from the consumer are provided by section 2108.

The virtual transaction site may provide recommendations for the forms to the extent legally permissible at section 2112. Then the virtual transaction site sets up a calendar system for sending out reminders regarding updating the will at section 2114. A flag indicating a will exists is provided to the virtual transaction site and a chosen funeral home, if any, at section 2126 so that additional evidence of the will are available.

The virtual transaction site also may provide an estate planner section 2116 that allows the consumer to set up an estate plan. An information section 2120 is provided to inform the consumer of estate plan details. An input forms section 2118 provides a set of estate plan forms selected by the consumer and receives input from the consumer to complete those forms. Form recommendations section 2122 provides guidance to the consumer regarding the forms to the extent legally permissible. Again, a calendar will be setup at section 2114 to send reminders to the consumer regarding updating the estate plan, and a flag noting the estate plan will be provided to the virtual transaction site and a chosen funeral home, if any, at section 2126.

A lawyer locator section 2124 may be provided to assist the consumer in finding a lawyer to assist in planning for the death and funeral. The lawyer locator section 2124 may provide a zip code based search as well as a search by practice area. The virtual transaction site may assist the consumer in obtaining the legal services by implementing the legal service transaction process as previously discussed.

The pre-need planning module 2104 also may provide a funeral planner wizard section 2128. This section links to a funeral planner that also provides functionality for the immediate-need funeral planner, discussed below. The funeral planner allows the consumer to set up the funeral by making various selections from provider information, including the GPL information provided by FDMs for funeral products and services. The funeral planner wizard implements a predetermined set of steps that guide the consumer through the various funeral service options and may provide a selection from predetermined groups of individual options.

The funeral planner provides an information section 2132 for assisting the consumer with the various choices to be made. An input forms section 2130 receives the selections from the consumer and output forms section 2134 provides guidance to the consumer in making the selections. A calendar is set up to periodically suggest to the consumer that the funeral plan be reviewed at section 2114, and a flag is set with the virtual transaction site and the chosen funeral home at section 2126 to maintain a record of the planned funeral.

FIG. 21B shows the continuation of the structure for the second portion of the pre-need planning sub-module 2006. A funeral director finder section 2136 is provided to assist the consumer in finding a funeral home and director to execute the funeral plan. The funeral home finder may maintain an index section 2138 containing funeral homes throughout the world, and may have specific listings for these funeral homes at local resource section 2140. This section may provide a section 2142 having email links to each of the funeral homes, and may provide a section 2144 having email links specifically for member funeral home websites. FIG. 34 illustrates a sample screen display provided by the funeral home finder section 2136 whereby the user can input geographical information to find a funeral home in an appropriate location.

A legacy section 2146 may be provided to allow the consumer to set up post-death communications. This section may provide an obituary section 2148 allowing the consumer to create his/her own virtual obituary that will be published on the transaction site and disseminated upon the consumer's death. Section 2150 may be provided to permit the consumer to set up targeted communications to specific people, such as individual letters to loved ones that may be disseminated upon the consumer's death.

A pre-funded arrangements section 2152 may be provided to permit the consumer to obtain funding, such as pre-need insurance, to cover the funeral arrangements being planned through the virtual transaction site. An arrangement planner section 2154 allows the consumer to determine the companies and the various products, (i.e., pre-need polices) available from catalog section 2158. Agent section 2156 allows the consumer to find an agent for purposes of obtaining the pre-need insurance policy. Agent section 2156 may direct consumers to funeral directors who may be knowledgeable in finding agents.

A notification services section 2160 is provided to allow the consumer to set up the manner in which others will be notified of the consumer's death. A notification composer section 2162 allows the consumer to draft the notice and then choose from various dissemination methods at bulk email section 2164, at E-card selector section 2168, and at standard mail section 2170. A sample copy section 2166 may be provided to disseminate a sample of the notification to the consumer for confirmation of the desired methods and notice. A shopping cart section 2172 is then provided to allow the consumer to finalize the purchase through the virtual transaction site where the notification and properties are then transferred to the production server.

FIG. 22 illustrates the remains sub-module 2008. The remains home page 2204 is accessed from the consumer home page 2004. A burials section 2206 is provided for consumers who choose to bury the remains. This section provides a ceremonies section 2208 where the consumer chooses the type of ceremony that will be performed at the burial. A body preparation section 2210 is provided to allow the consumer to choose the manner in which the body will be prepared, including the type of clothing to be used.

A cremation section 2212 is provided for consumers wishing to cremate the remains. The cremation section 2212 may provide several sub-sections include a section 2214 containing links to information regarding cremation. A ceremonies sub-section 2216 may be provided to allow the consumer to choose the type of ceremony that will be performed before and/or after the cremation. A body preparation section 2218 may be provided to assist the consumer in making choices related to the cremation. A links section 2224 may be provided to inform the consumer of ash distribution, the Neptune society, and other cremation related information. A locator section 2226 may be included to allow the consumer to search for cremation related organizations.

A body donation section 2220 may be included to allow the consumer to opt to donate the remains to science. An organs donation section 2228 may be included to allow the consumer to opt to donate organs for transplant purposes. An information section 2222 is provided to explain the donation process to consumers. An on-line registration section 2230 is provided to allow the consumer wishing to donate to register with the virtual transaction site, chosen funeral home, and with the appropriate organization.

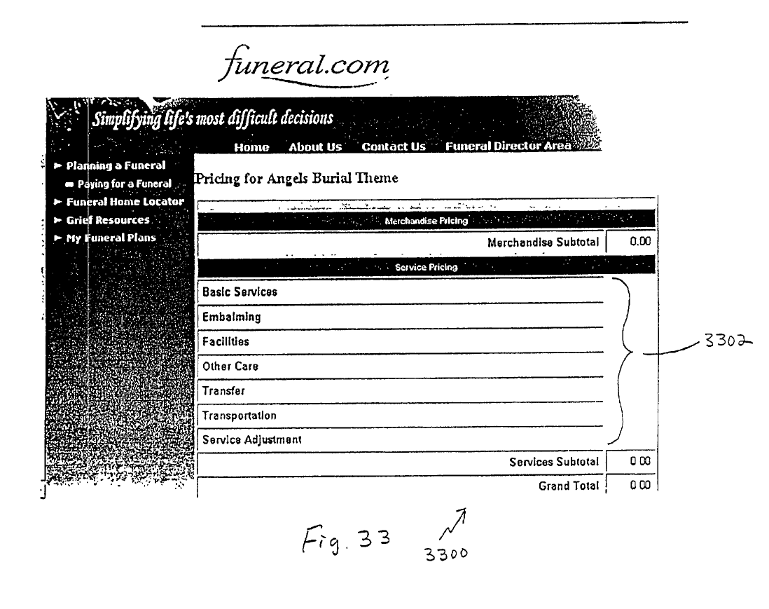

FIG. 23A illustrates a first portion of the funeral planning sub-module 2010 accessed directly from the consumer home page 2004 for immediate-need planning and accessed for pre-need planning by linking from the pre-need home page. The funeral planner home page 2304 provides the consumer a planner/wizard section 2306 as well as individual option selection sections. The planner/wizard section 2306, and shown in more detail in FIG. 24, allows the consumer to proceed through a predetermined set of steps that guide the consumer through the planning process (i.e., choose funeral home, choose method for remains, choose casket, choose music, or choose themed package) so that the consumer need not manually navigate through all of the funeral planning options. The predetermined set of steps may take the consumer through all of the necessary planning decisions or through a part of them. Furthermore, the planner/wizard may provide pregrouped package selections (i.e., themed packages for a veteran, golfer, etc. having music, casket, clothing, etc. preselected) for the consumer to greatly reduce the number of decisions the consumer must make. As discussed, FIG. 32 illustrates an exemplary screen display provided by the planner/wizard section 2306 for accepting a themed package selection from a consumer. FIG. 33 illustrates an exemplary screen display provided by the planner/wizard section 2306 for providing pricing information retrieved from GPL database 132 in various informational fields 3302 to the consumer after having chosen a themed package.

An urns section 2308 may be provided for consumers who choose to maintain the cremated remains in an um. An information section 2318 is provided for the urns to assist the consumer in making an educated decision. The urns section 2308 of one embodiment provides the consumer the ability to search for the urns made available through the catalog of the funeral home of choice at section 2326. In other embodiments, the urns section as well as the other product sections of the funeral planner module 2304 may permit the consumer to view the products catalog populated by the member suppliers to increase the selection. A shopping cart may be provided by this section which then leads to a purchase pipeline 2336 that records the purchase in the production server and disseminates the purchase request to the appropriate supply entity.

A caskets section 2310 may be provided for consumers choosing to bury the remains. An information section 2320 and a catalog/shopping cart section 2328 are similarly provided. Again, the purchase is recorded in the production server through purchase pipeline 2336 and is disseminated to the appropriate supply entity.

A vaults section 2312 may be provided for consumers choosing to place the remains in a vault. An information section 2322 and a catalog/shopping cart section 2330 are provided. The vault purchase is channeled through the purchase pipeline 2336.

A flowers section 2314 may be provided for consumers to choose the appropriate flowers to include in the funeral service. The flowers section 2314 is linked to distributors 2334 who provide the flowers. The flowers section 2314 also may be setup so that a purchase flows through a catalog/shopping cart and through the purchase pipeline 2336.

A music section 2316 may be provided for consumers to choose the appropriate music to be played during the funeral service. The music section may be linked through a music information section 2324 that provides music samples and links 2332 that assist the consumer in choosing the appropriate music.

FIG. 23B shows a second portion of the funeral planner sub-module 2010. A memorial folder section 2338 is provided to allow the consumer to create a memorial folder for the funeral service. A design wizard section 2344 is provided to allow the consumer to design his/her own folder. A content library 2350 may be provided to assist the design process and may link to options provided by paper manufacturers 2356. The folder design is then disseminated to the paper manufacturer 2356 for production at the appropriate time.

A catalog page 2346 is also provided to allow the consumer to choose from stock designs. The consumer then purchases the stock design through the shopping cart 2352. The purchase may then be disseminated through the purchase pipeline previously discussed.

A notifications section 2340 may be provided, as was discussed with reference to the pre-need planning section. Again the notification section allows the consumer to compose notices. The consumer may then select the manner of dissemination such as bulk email, E-cards, and standard mail.

A regulation information section 2342 may be provided by the funeral planner as well. This section allows the consumer to review state regulations regarding funeral topics by sorting by the state and the regulation type of interest. An index section 2348 is provided to locate detail pages 2354 for the particular state and regulation type selected.

FIG. 24 shows the planner/wizard section 2306 in more detail. The planner/wizard section 2306 is accessed through the funeral planner home page 2304. The planner/wizard then allows the consumer to choose products and services at section 2406. As previously discussed, this section may guide the consumer through a step-by-step process implemented by a funeral planner 2408. The consumer also may choose to independently navigate to plan the funeral.

The planner/wizard also allows the consumer to find the necessary entities for the funeral process at contact section 2410. This section provides a funeral director finder 2412, a church finder 2414, and a cemetery finder 2416. These finders may be indexed according to various parameters such as zip code which the consumer may use to fitter the results of a contact search.

FIG. 25A shows a first portion of the obituaries sub-module 2012. The obituaries home page 2504 is accessed from the consumer home page 2004. The obituaries section 2504 has a virtual obituaries section 2506. Here, the consumer may navigate to an options page 2508 where the consumer may login, create obituaries, or locate previously created or published obituaries.

Consumers choosing to locate an obituary are given access to an index page 2514. Here, the consumer may search for the obituary of interest through the obituary library 2530. The consumer also may join or open an on-line discussion forum for the deceased in the obituary at section 2540. From this section, the consumer may elect at section 2543 that the virtual transaction site make a book of the discussion and send it to one or more participants.

If an obituary is private, then the consumer must pass through security page 2516 which may request a password from the consumer. The consumer may then view the private obituary from the private obituary library 2532 and then open or join the on-line discussion at section 2540. Again, the consumer may elect to have the virtual transaction site create a book of the discussion.

If the consumer chooses to create a virtual obituary at options page 2508, the consumer is directed to creation page 2510 where the consumer may generate the content for the obituary. The consumer may be given several options for creating the virtual obituary, including a standard section 2518 where a stock obituary setup is used. The consumer chooses a stock obituary form at section 2524, sets up a password for the obituary at section 2534, and enters the submission information for the form at section 2544.

The consumer is given an option for creating a custom virtual obituary at section 2520. The consumer may select a single page obituary at section 2526 or a multi-page obituary at section 2528. The consumer sets up a password at section 2534 and enters the submission information at section 2544. The consumer may customize the obituary at this section by adding the content found at the resources section 2522, including alt from an art library 2536 and music clips at section 2546. The consumer also may choose an epitaph at section 2538 and may search for an appropriate one using index section 2548 which searches through the various epitaph resources 2550 available to the virtual transaction site.

FIG. 25B shows a second portion of the obituaries sub-module 2012 for non-virtual obituaries. The consumer may choose non-virtual obituaries from the obituaries home page 2504. The consumer chooses the state for the obituary at section 2552. A newspaper index page 2556 for the chosen state is provided to allow the consumer to choose the newspapers to search for the obituary. The obituary sections of the chosen newspapers are provided at section 2558, and the consumer may elect to order flowers for the deceased at flowers section 2560 which may link to distributors or may proceed through the purchase pipeline. The consumer may choose to disseminate a non-virtual obituary at notification section 2554 where the consumer may include the submission information and then select the newspapers to publish the obituary.

FIG. 26 shows the cemeteries sub-module 2014. The cemeteries home page 2604 is accessed from the consumer home page 2004. Several options are provided to the consumer including a monuments section 2606. Here, the consumer can select to create a monument at create section 2616, view different types of monuments at section 2618 including historical uses of the various types, and read information for caring for the monument at section 2620.

The consumer may choose to view classifieds listings for burial property at section 2608. The consumer also may choose to find a cemetery at section 2610. The consumer enters the state or region where the cemetery should be located at section 2624. A locator section 2626 then searches for the cemeteries within the region or state specified. The consumer may be given additional information, such as the layout of a chosen cemetery and the available plots which can then be purchased through the virtual transaction site.

The cemeteries home page 2604 may provide a grave finder section 2612 that enables the consumer to search for the grave site of others. The section may be broken into a section 2628 for searching for anyone or a set of sections that look for the grave site of a person from a particular category. For example, a historical figures section 2634, a Hollywood section 2630, a soldiers section 2636, a wild west section 2632, and a politicians section 2638 may be provided to find the grave site of famous people, etc.

FIG. 27 shows the grieving sub-module 2016. The grieving home page 2704 is accessed from the consumers home page 2004. The grieving home page 2704 provides various options for the consumer related to the grieving process. A counselor locator section 2706 is provided to assist the consumer in finding counseling when necessary. An index page 2708 is provided to search through the library of counselors 2710 maintained by the virtual transaction site.

A support-group section 2712 provides links to various support groups. An index page 2714 is provided to search through the library of support groups 2716 and support group links 2728 maintained by the virtual transaction site. The library may be broken into a section 2718 for specific situations and a section 2720 for specific survivors. The specific situations section 2718 may contain a section 2722 containing links to various death related situations such as AIDS. The specific survivors section 2720 may contain a section 2724 containing links to various survivors such as seniors or children.

A books section 2730 may be provided with an index page 2732 for finding books related to death maintained in a virtual book library 2734 by the transaction site. A section 2736 for other resources also may be provided to the consumer to address other grief related issues.

FIG. 28 shows the cultural perspectives sub-module 2018. The cultural perspectives home page 2804 is accessed from the consumer page 2004. The cultural perspectives home page 2804 provides death related cultural information to the consumer. An index page 2806 for various cultures is protruded for the consumer to select the culture of interest.

A remains section 2808 is provided to inform the consumer as to how the remains are treated for the selected culture. A funeral rites and services section 2810 is provided to inform the consumer as to how the funeral service is performed for the selected culture. A cemeteries and burial section 2812 is provided to inform the consumer as to how the burial, if any, is handled for the selected culture. A religious ideas section 2814 is provided to inform the consumer of the religious ideas, traditions, etc. related to death for the selected culture.

FIG. 29 shows the resources sub-module 2020. The resources home page 2904 is accessed from the consumers home page 2004. The resources home page 2094 provides access for the consumer to various collateral issues. For example, a legal assistance section 2906 is provided to assist the consumer in obtaining legal services related to the death.

An index page 2908 is provided to assist the consumer find an attorney from the library 2910 of attorneys maintained by the transaction site. The index page 2908 also aids the consumer in finding legal insurance at section 2912. The consumer may purchase the legal insurance through the shopping cart 2914 associated with the virtual transaction site.

A societies section 2916 may be included to provide the consumer with information about death related societies. An index page 2918 is provided to assist the consumer with finding the relevant societies within the society library 2920 maintained by the transaction site. A hospice section may be provided to inform the consumer about hospice care for the dying from the information section 2924. A books section 2926 may be provided with an index page 2928 assisting consumers in finding relevant books and writings in the library 2930 maintained by the transaction site. A death related links page 2932 with additional information of interest also may be provided for consumers.

FIG. 30 shows a kids sub-module 2022. The kids home page 3004 is accessed from the consumers home page 2004. The kids home page 3004 provides several options devoted to children. An education section 3006 provides information tailored to children to educate them about the dying process including funerals and caring for remains. A what to expect section 3008 guides the children through the funeral process.

The kids home page 3004 also provides a cultural information section 3010 that is tailored for children to help them understand the traditions and rituals of various cultures. A grief section 3012 designed for children provides aides that help children deal with the loss of a loved one. A resources section 3014 provides information about funeral related books that children might find informative as well as a locator for counselors and other professionals who specialize in dealing with children.

FIG. 31 shows a pets sub-module 2024. The pets home page 3104 is accessed from the consumers home page 2004. The pets home page 3104 provides several sections devoted to the death of a pet. A funeral planner section 3106 with notification features is provided, and the consumer may purchase funeral products, services, and plans for their pet at the catalog/shopping cart section 3122.

The pets home page 3104 also provides a pet cemetery section 3108 and a pet funeral home section 3110 to assist consumers in finding establishments that handle memorializing pets and dealing with pet remains. Each of these sections is linked to a cemetery and funeral home locator, 3124 and 3126, respectively. A virtual obituaries section 3112 also may be provided to enable consumers to post obituaries in the virtual transaction site about their pets and to read the virtual pet obituaries that others have posted.

The pets home page 3104 also provides a remains section 3114 that assists consumers in deciding how to handle the remains of their pet. A euthanization section 3128 informs consumer of the euthanization process and is linked to a vet locator section 3130 to assist consumers in finding a vet to handle euthanization of their pet. A bury/cremate section 3132 provides information to consumers to assist them in deciding whether to bury or cremate their pet. A taxidermy section 3134 provides information to consumers about taxidermy, and a linked locator section 3136 assists the consumer in finding a taxidermist.

The pets home page 3104 also provides a grief section 3116 with information to assist consumers in dealing with the loss of their pet. A resources section 3118 provides additional information related to the death of a pet, and a book section 3138 provides a list of relevant reading materials. A flowers section 3120 also may be included to allow consumers to order flowers when a pet has died.

While the invention has been particularly shown and described with reference to preferred embodiments thereof, it will be understood by those skilled in the art that various other changes in the form and details may be made therein without departing from the spirit and scope of the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer-network apparatus for integrating communication between parties involved with the funeral process, the apparatus comprising:
memory having first and second storage locations, the first storage location including data related to funeral product information and the second storage location including data related to funeral home information; and
a network server in data communication with the memory and having a network interface, the network server having a processor configured to
(i) receive electrical signals embodying funeral product information through the interface from a supplier client device, and store the funeral product information in the first storage location;
(ii) provide electrical signals embodying funeral product information stored in the first storage location to a funeral home client device through the interface;
(iii) receive electrical signals embodying funeral home information from the funeral home client device through the interface, the funeral home information including selections from information stored in the first storage location, and store the funeral home information in the second storage location; and
(iv) provide electrical signals embodying funeral home information stored in the second storage location to a consumer client device through the interface.

2. The apparatus of claim 1, wherein the funeral home information stored in the second storage location includes links to information in the first storage location.

3. The apparatus of claim 1, wherein the funeral home information stored in the second location includes duplications of information in the first storage location.

4. The apparatus of claim 1, wherein the interface is in electrical communication with the Internet.

5. The apparatus of claim 1, wherein the memory is a plurality of databases.

6. A computer-network apparatus for integrating communication between parties involved with the funeral process, the apparatus comprising:
a memory for storing funeral process information; and
a network server in electrical communication with the memory and a network interface, the network server including a processor configured to
(i) provide an electrical signal embodying a menu of funeral process items to a client device through the interface, each menu item corresponding to a set of data stored in the memory,
(ii) determine the appropriate set of data to retrieve from the memory in response to selection of one of the memory items, and
(iii) provide an electrical signal embodying the appropriate set of data to the client device through the interface.

7. The apparatus of claim 6, wherein the selection corresponds to product supplier information.

8. The apparatus of claim 7, wherein the product supplier information includes a list of products offered by product suppliers and associated prices.

9. The apparatus of claim 6, wherein the client device is a funeral home client device and wherein the network server provides an electrical signal embodying the appropriate set of data to the funeral home client device in response to receiving an electrical signal from the funeral home client device embodying an authentication code and determining from the authentication code that the funeral home client device is authorized to receive the appropriate set of data.

10. The apparatus of claim 6, wherein the selection corresponds to funeral home information.

11. The apparatus of claim 10, wherein the funeral home information includes a list of products and services and associated retail prices.

12. The apparatus of claim 6, wherein the client device is a consumer client device and wherein the network server provides an electrical signal embodying the appropriate set of data to the consumer client device in response to receiving an electrical signal from the funeral home client device embodying an authentication code and determining from the authentication code that the consumer client device is authorized to receive the appropriate set of data.

13. The apparatus of claim 6, wherein the client device is a supplier client device and wherein the network server provides an electrical signal embodying the appropriate set of data to the supplier client device in response to receiving an electrical signal from the funeral home client device embodying an authentication code and determining from the authentication code that the supplier client device is authorized to receive the appropriate set of data.

14. The apparatus of claim 6, wherein the selection corresponds to a funeral planner, and wherein the set of data includes computer code that causes the client device to proceed through a predetermined set of funeral planner steps with each step displaying a funeral plan option on a display of the client device, and wherein each step results in the client device providing an electrical signal embodying funeral plan option selections to the network server through the interface.

15. A computer data signal embodied in a transmitted wave readable by a computer system and encoding a computer program of instructions for executing a computer process, the computer process comprising:
(i) displaying, in a sequence, a funeral plan option from a set of funeral plan options on a display of a client device for executing the computer process,
(ii) receiving a funeral plan option selection through an input device of the client device,
(iii) proceeding to a next funeral plan option to receive another funeral plan option selection, and
(iv) transmitting from the client device a computer data signal embodying the funeral product option selections made during each of the funeral planner steps.

16. A method for integrating communication between parties involved with the funeral process with a computer-implemented apparatus having a memory having first, second, and third storage locations, and a network server in data communication with the memory and having a network interface and a processor, the method comprising:
receiving, at the processor, electrical signals embodying funeral product information through the interface from a supplier client device and storing, by the processor, the funeral product information in the first storage location,
providing, by the processor, electrical signals embodying funeral product information stored in the first storage location to a funeral home client device through the interface,
receiving, at the processor, electrical signals embodying funeral home information from the funeral home client device through the interface, the funeral home information including selections from information stored in the first storage location, and storing, by the processor, the funeral home information in the second storage location,
providing, by the processor, electrical signals embodying funeral home information stored in the second storage location to consumer a client device through the interface.

17. The method of claim 16, wherein the interface is in electrical communication with the Internet.

18. The method of claim 16, wherein the memory is a plurality of databases.

19. A method for integrating communication between parties involved with the funeral process with a computer-implemented apparatus having a memory for storing funeral process information and a network server in electrical communication with the memory and a network interface, the network server including a processor, the method comprising:
providing, by the processor, an electrical signal embodying a menu of funeral process items to a client device through the interface, each menu item corresponding to a set of data stored in memory;
determining, by the processor, the appropriate set of data to retrieve in response to selection of one of the menu items; and
providing an electrical signal embodying the appropriate set of data to the client device through the interface.

20. The method of claim 19, wherein the selection corresponds to product supplier information.

21. The method of claim 20, wherein the product supplier information includes a list of products offered by product suppliers and associated prices.

22. The method of claim 19, wherein the client device is a funeral home client device.

23. The method of claim 19, wherein the selection corresponds to funeral home information.

24. The method of claim 23, wherein the funeral home information includes a list of products and services and associated prices.

25. The method of claim 19, wherein the client device is a consumer client device.

26. The method of claim 19, further comprising receiving a second selection from the menu from the client device through the interface, receiving an electrical signal embodying additional funeral process information from the client device through the interface, and storing the additional funeral process information in an appropriate location in the memory as indicated by the second selection.

27. The apparatus of claim 19, wherein the selection corresponds to a funeral planner and the appropriate set of data includes computer program of instructions for executing a computer process, the computer process comprising:
(i) displaying, in a sequence, a funeral plan option from a set of funeral plan options on a display of a client device for executing the computer process,
(ii) receiving a funeral plan option selection through an input device of the client device,
(iii) proceeding to a next funeral plan option to receive another funeral plan option selection, and
(iv) transmitting from the client device a computer data signal embodying the funeral product option selections made during each of the funeral planner steps.
